(19) United States
(12) Patent Application Publication
(10) Pub. No.: US 2025/0177865 A1
(43) Pub. Date: Jun. 5, 2025

(54) METHOD AND APPARATUS FOR CONTROLLING AI VIRTUAL OBJECT, DEVICE, AND STORAGE MEDIUM

(71) Applicant: Tencent Technology (Shenzhen) Company Limited, Shenzhen (CN)

(72) Inventors: Yang ZHANG, Shenzhen (CN); Sze Yeung Liu, Shenzhen (CN)

(21) Appl. No.: 19/044,454

(22) Filed: Feb. 3, 2025

Related U.S. Application Data
(63) Continuation of application No. PCT/CN2023/130914, filed on Nov. 10, 2023.

(30) Foreign Application Priority Data
Feb. 7, 2023 (CN) 202310125722.9

(51) Int. Cl. A63F 13/55; A63F 13/822; G06T 13/40; G06T 19/00; G06V 10/762

(52) U.S. Cl. CPC A63F 13/55; A63F 13/822; G06T 13/40; G06T 19/00; G06V 10/762

(57) ABSTRACT

Provided are a method for controlling an artificial intelligence (AI) virtual object in a virtual environment performed by a computer device. The method includes: determining an AI virtual object located within an observation range of a player virtual object; determining a current level of details (LOD) of the AI virtual object based on at least two levels of LOD determining strategies corresponding to the AI virtual object, wherein the current LOD is an LOD corresponding to a target LOD determining strategy which the AI virtual object satisfies; and controlling, based on a control strategy corresponding to the current LOD, the AI virtual object to carry out an activity in the virtual environment. By using the above method, apparatus, device, and storage medium, LOD determining standards can be enriched, and diversity of strategies for controlling the AI virtual object can be increased.

### CROSS-REFERENCE TO RELATED APPLICATIONS

This application is a continuation application of PCT Patent Application No. PCT/CN2023/130914, entitled “METHOD AND APPARATUS FOR CONTROLLING AI VIRTUAL OBJECT, DEVICE, AND STORAGE MEDIUM” filed on Nov. 10, 2023, which claims the benefit of priority to Chinese Patent Application no. 202310125722.9, entitled “METHOD AND APPARATUS FOR CONTROLLING AI VIRTUAL OBJECT, DEVICE, AND STORAGE MEDIUM” filed on Feb. 7, 2023, both of which are incorporated herein by reference in their entirety.

### FIELD OF THE TECHNOLOGY

Embodiments of this application relate to the technical field of computers, and particularly relate to a method and apparatus for controlling an artificial intelligence (AI) virtual object, a device, and a storage medium.

### BACKGROUND OF THE DISCLOSURE

A huge number of artificial intelligence (AI) virtual objects exist in open-world games. The AI virtual object is a non-player character (NPC) having a personified behavior.

In a related technology, to increase reality of the AI virtual object, a level of details (LOD) of the AI virtual object is determined by determining a distance between the AI virtual object and a player virtual object. Then, the AI virtual object is controlled correspondingly based on the determined LOD.

### SUMMARY

Embodiments of this application provide a method and apparatus for controlling an artificial intelligence (AI) virtual object, a device, and a storage medium, which can enrich determining standards of a level of details (LOD), and increase diversity of strategies for controlling the AI virtual object. Technical solutions are as follows:

In a first aspect, an embodiment of this application provides a method for controlling an AI virtual object in a virtual environment performed by a computer device and the method includes:
determining an AI virtual object located within an observation range of a player virtual object;
determining a current level of details (LOD) of the AI virtual object based on at least two levels of LOD determining strategies corresponding to the AI virtual object, wherein the current LOD is an LOD corresponding to a target LOD determining strategy which the AI virtual object satisfies; and
controlling, based on a control strategy corresponding to the current LOD, the AI virtual object to carry out an activity in the virtual environment.

In yet another aspect, an embodiment of this application provides a computer device. The computer device includes a processor and a memory. The memory has at least one program stored therein. The at least one program is loaded and executed by the processor, to cause the computer device to implement the method for controlling an AI virtual object in a virtual environment as mentioned in the above aspect.

In yet another aspect, an embodiment of this application provides a non-transitory computer-readable storage medium. The non-transitory computer-readable storage medium has at least one program stored therein. The at least one program is loaded and executed by a processor, to cause a computer to implement the method for controlling an AI virtual object in a virtual environment as mentioned in the above aspect.

In embodiments of this application, in a case of an AI virtual object located within an observation range of a player virtual object, a current LOD of the AI virtual object is determined based on at least two levels of LOD determining strategies corresponding to the AI virtual object such that the AI virtual object can be controlled according to a control strategy corresponding to the current LOD. Thus, determining standards for determining the LOD of the AI virtual object are enriched, and diversity of strategies for controlling the AI virtual object is increased. Moreover, in embodiments of this application, different LOD determining strategies each include at least two determining sub-strategies. Different determining sub-strategies correspond to determining bases in different dimensions. Relatively rich dimensions are considered in a process of determining an LOD such that reliability of determining an LOD can be improved. Thus, reliability of a control strategy corresponding to an AI virtual object can be improved, unnecessary power consumption can be reduced, and a display effect of the AI virtual object in a virtual scenario can be optimized. Further, visual experience of a player can be improved, and a human-computer interaction rate can be improved.

### BRIEF DESCRIPTION OF THE DRAWINGS

FIG. 1 shows a schematic diagram of determining a level of details (LOD) of an artificial intelligence (AI) virtual object in a related technology;

FIG. 2 shows a schematic diagram of an interface representation of an AI virtual object according to an exemplary embodiment of this application;

FIG. 3 shows a schematic diagram of a computer system according to an exemplary embodiment of this application;

FIG. 4 shows a flow diagram of a method for controlling an AI virtual object according to an exemplary embodiment of this application;

FIG. 5 shows a schematic diagram of determining a current LOD of an AI virtual object according to an exemplary embodiment of this application;

FIG. 6 shows a flow diagram of a method for controlling an AI virtual object according to another exemplary embodiment of this application;

FIG. 7 shows a flow diagram of a method for controlling an AI virtual object according to yet another exemplary embodiment of this application;

FIG. 8 shows a schematic diagram of determining a current LOD of an AI virtual object according to an exemplary embodiment of this application;

FIG. 9 shows a flow diagram of a method for controlling an AI virtual object according to yet another exemplary embodiment of this application;

FIG. 10 shows a flow diagram of a logical operation of an LOD determining strategy according to an exemplary embodiment of this application;

FIG. 11 shows a flow diagram of a method for controlling an AI virtual object according to yet another exemplary embodiment of this application;

FIG. 12 shows a schematic diagram of determining a current LOD of a target AI virtual object cluster according to an exemplary embodiment of this application;

FIG. 13 shows a flow diagram of a method for controlling an AI virtual object according to still another exemplary embodiment of this application;

FIG. 14 shows a schematic diagram of determining a current LOD of an AI virtual object according to an exemplary embodiment of this application;

FIG. 15 shows three stages of determining a control strategy for controlling an AI virtual object according to an exemplary embodiment of this application;

FIG. 16 shows a flow diagram of a method for controlling an AI virtual object according to another exemplary embodiment of this application;

FIG. 17 shows a structural block diagram of an apparatus for controlling an AI virtual object according to an exemplary embodiment of this application; and

FIG. 18 shows a schematic structural diagram of a computer device according to an exemplary embodiment of this application.

### DESCRIPTION OF EMBODIMENTS

Exemplary embodiments will be described in detail herein, and examples of the exemplary embodiments are shown in accompanying drawings. When the following description involve accompanying drawings, unless otherwise denoted, the same numerals in different accompanying drawings denote the same or similar elements. The implementations described in the following exemplary embodiments do not represent all implementations consistent with this application. On the contrary, the implementations are merely examples of an apparatus and a method consistent with some aspects of this application as detailed in the appended claims.

The term “several” mentioned herein means one or more, and the term “plurality of” means two or more. The term “and/or” describing an association relationship between associated objects denotes that there can be three relationships. For example, A and/or B can denote: A alone, both A and B, and B alone. The character “/” generally denotes an “or” relationship between the associated objects.

Terms involved in embodiments of this application will be briefly introduced below.

Level of details (LOD): a level of picture fineness or logical complexity in a game.

Virtual environment: a virtual environment displayed (or provided) when a client is run on a terminal. The virtual environment may be a simulated environment of a real world, a semi-simulated semi-fictional environment, or a purely-fictional environment. The virtual environment may be any one of a two-dimensional virtual environment, a 2.5-dimensional virtual environment, and a three-dimensional virtual environment, which is not limited in this application. In some embodiments, the virtual environment may be referred to as a virtual scenario. An example in which the virtual environment is a three-dimensional virtual environment is taken for description in the following embodiments.

In some embodiments, the virtual environment can provide a battle environment of a virtual object. For example, in an open-world game, a player may freely control a virtual object to roam in a virtual environment, and may freely select a time point and a method of completing a game task. In a roaming process, the virtual object controlled by the player continuously interacts with an artificial intelligence (AI) virtual object in the virtual environment. In a battle royale type game, at least one virtual object plays a single-round battle in the virtual environment. The virtual object escapes an attack launched by an enemy unit and dangers (such as a poison gas circle and a swamp) in the virtual environment to survive in the virtual environment. When a hit point value of the virtual object in the virtual environment is zero, life of the virtual object in the virtual environment ends, and a virtual object finally successfully passing a route in a level is a winner. For example, in a mission completion type game, at least one virtual object plays a single-round battle in a virtual environment. The virtual object acquires permission to pass a current level by killing a monster, to enter a next level or end a current battle.

Virtual object: a movable object in a virtual environment. The movable object may be a virtual person, a virtual animal, a cartoon person, etc., such as a person or an animal displayed in a three-dimensional virtual environment. In some embodiments, the virtual object is a three-dimensional model created based on a skeletal animation technology. Each virtual object has a shape and a volume in the three-dimensional virtual environment, and occupies a part of a space in the three-dimensional virtual environment. In some embodiments, the virtual object may be referred to as a virtual character. In this application, an AI virtual object and a player virtual object exist in a virtual environment. The AI virtual object is a non-player character (NPC) having a personified behavior. The player virtual object is a virtual object controlled by a player.

In this application, an AI virtual object and a player virtual object exist in a virtual environment. The AI virtual object is an NPC having a personified behavior. The player virtual object is a virtual object controlled by a player. In a related technology, LODs are divided by taking a player virtual object as a center. An LOD of each AI virtual object is determined based on a distance between the AI virtual object and the player virtual object. Thus, the AI virtual object is controlled by using a control strategy corresponding to a current LOD.

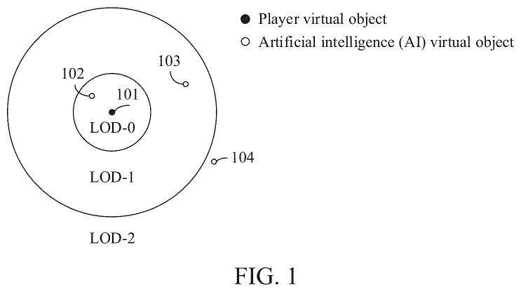

FIG. 1 shows a schematic diagram of determining an LOD of an AI virtual object in a related technology. In FIG. 1, a plurality of LODs, which are LOD-0, LOD-1, and LOD-2 respectively, are generated by taking a player virtual object as a center according to a distance length. Different LODs correspond to different impact ranges. The higher the level, the smaller the impact range. For example, if a level of LOD-0 is higher than that of LOD-1, an impact range corresponding to LOD-0 is smaller than an impact range corresponding to LOD-1.

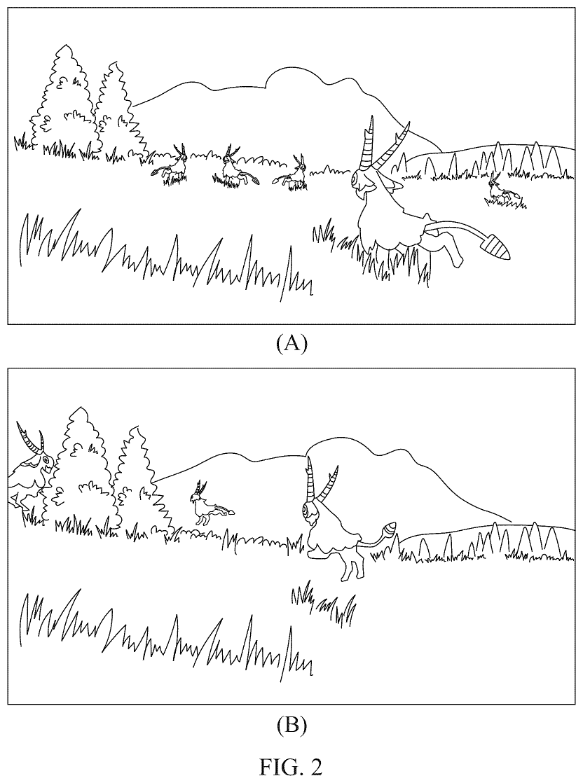

As shown in FIG. 1, according to a distance between a first AI virtual object 102 and a player virtual object 101, an LOD corresponding to the first AI virtual object 102 can be determined as LOD-0. Thus, the first AI virtual object 102 is controlled by using a control strategy corresponding to LOD-0. Similarly, according to a distance between the second AI virtual object 103 and the player virtual object 101, an LOD corresponding to the second AI virtual object 103 can be determined as LOD-1. According to a distance between the third AI virtual object 104 and the player virtual object 101, an LOD corresponding to the third AI virtual object 104 can be determined as LOD-2. Thus, the second AI virtual object 103 is controlled by using a control strategy corresponding to LOD-1. The third AI virtual object 104 is controlled by using a control strategy corresponding to LOD-2. Processing logic of control strategies corresponding to AI virtual objects having different LODs is different. The lower an LOD (the greater an LOD value), the simpler processing logic of an AI virtual object, the coarser an interface representation, and the lower performance consumption. As shown in FIG. 2, a part (B) of FIG. 2 shows a representation of an AI virtual object within an impact range of LOD-2. In this case, the AI virtual object moves in a direct translation manner, and limbs of the AI virtual object already depart from the ground. The reason is that a control strategy corresponding to LOD-2 does not use rigorous pathfinding and a movement algorithm to control the AI virtual object to move, but only performs interpolation and translation between a start point and an end point. Apart (A) of FIG. 2 shows a representation of an AI virtual object within an impact range of LOD-0. In this case, the AI virtual object normally moves.

However, a large number of AI virtual objects exit in an open-world game. LODs are divided only by taking a player virtual object as a center. Moreover, an LOD corresponding to each AI virtual object is determined according to a distance between the AI virtual object and the player virtual object. Consequently, an LOD determining strategy for the AI virtual object is single, and a plurality of levels of LOD strategy determining cannot be performed on the AI virtual object. Thus, a control effect on the AI virtual object in the game is reduced, visual experience of a player is reduced, and a human-computer interaction rate is reduced.

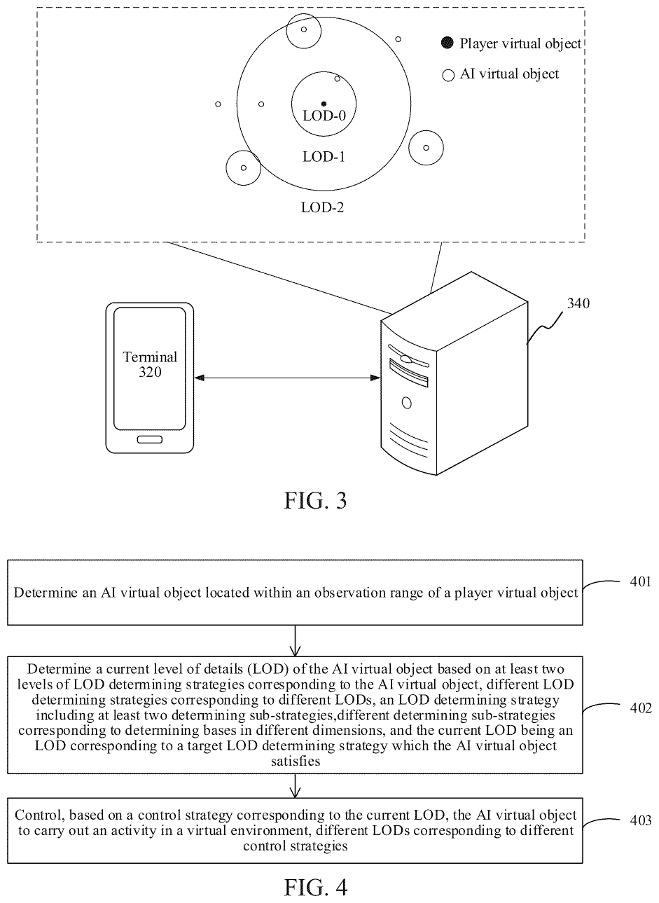

FIG. 3 shows a schematic diagram of a computer system according to an exemplary embodiment of this application. The computer system includes: a terminal 320 and a server 340.

An application supporting a virtual environment is installed and run on the terminal 320. The application may be any one of a massively multiplayer online game (MMOG), a role-playing game (RPG), a three-dimensional map program, a virtual reality (VR) application, and an augmented reality (AR) program. The terminal 320 is a terminal used by a user. The user controls a virtual character located in a virtual environment to carry out an activity by the terminal 320. The activity includes but is not limited to: at least one type of adjusting a body posture, walking, running, jumping, riding, driving, aiming, picking up, using a throwing prop, or attacking another virtual character. For example, the virtual character is a virtual person, such as a simulated person object or a cartoon person object. In some embodiments, an external connection device is further connected to the terminal 320, such as: a mouse, a keyboard, a handle, audio electronics, virtual reality (VR)/augmented reality (AR) glasses, and a VR/AR helmet. The user exchanges data with the terminal 320 by an external connection device, to control a virtual character to carry out an activity in a virtual environment.

The terminal 320 is connected to the server 340 over a wireless network or a wired network.

The server 340 includes at least one type of a server, a plurality of servers, a cloud computing platform, and a virtualization center (only one server is shown in FIG. 2). For example, the server 340 includes a processor and a memory. The memory includes a receiving module, a controlling module, and a transmitting module. The receiving module is configured to receive a request sent by the client, such as a request to form a team. The controlling module is configured to control rendering of a virtual environment picture. The transmitting module is configured to transmit a response to the client, for example, transmit, to the client, reminding information indicating that a team is formed. The server 340 is configured to provide a background service for an application supporting a three-dimensional virtual environment. In some embodiments, the server 340 is responsible for primary computing work, and the terminal 320 is responsible for secondary computing work; the server 340 is responsible for secondary computing work, and the terminal 320 is responsible for primary computing work; or a distributed computing architecture is used between the server 340 and the terminal 320 for collaborative computing.

In some embodiments, applications installed on the terminal 320 are applications on different operating system platforms (such as Windows, Mac, and Linux). The terminal 320 may generally refer to one of a plurality of terminals. The terminal 320 is only used as an example for description in the embodiment. A device type of the terminal 320 includes: at least one type of a desktop computer, a laptop computer, a smartphone, a smart television, a wearable device, a tablet computer, a vehicle terminal, an ebook reader, a moving picture experts group audio layer III (MP3) player, and a moving picture experts group audio layer IV (MP4) player.

A person skilled in the art can know that more or fewer terminals 320 can be provided. For example, only one terminal 320 is arranged, dozens or hundreds of terminals 320 are arranged, or more terminals are arranged. A number and device types of terminals 320 are not limited in embodiments of this application.

In this application, the terminal 320 or the server 340 executes a process shown in FIG. 4 that a current LOD of an AI virtual object is determined based on a plurality of levels of LOD determining strategies corresponding to the AI virtual object, to control the AI virtual object by using a control strategy corresponding to the current LOD. In an embodiment, a plurality of AI virtual objects exist in a virtual environment, and each AI virtual object corresponds to at least two levels of LOD determining strategies. Thus, in a case of an AI virtual object located within an observation range of a player virtual object, a current LOD of the AI virtual object is determined according to the at least two levels of LOD determining strategies corresponding to the AI virtual object such that the AI virtual object can be controlled by using a control strategy corresponding to the current LOD.

With reference to FIG. 4, a flow diagram of a method for controlling an AI virtual object according to an exemplary embodiment of this application is shown. An example in which the method is executed by a computer device (including a terminal 320 and/or a server 340) shown in FIG. 3 is used for description. The method includes operation 401 to operation 403 as follows:

Operation 401: Determine an AI virtual object located within an observation range of a player virtual object.

In some embodiments, the AI virtual object refers to an NPC having a personified behavior. In some embodiments, the AI virtual object is an movable object in a virtual environment controlled by a state machine or a behavior tree. In some embodiments, the AI virtual object may be referred to as an Agent.

In some embodiments, a player virtual object refers to a movable object controlled by a player. In some embodiments, the player virtual object may be referred to as a Player. Generally, in a three-dimensional game, a camera model exits to observe a virtual environment. The camera model is generally arranged at a position such as a head, a right shoulder, or a back of a player virtual object such that a player can substitute the player virtual character for a role-playing game. In a related technology, since an LOD of an AI virtual object is determined according to only a distance, when the AI virtual object is far away from a player virtual object, the AI virtual object is controlled by using a relatively simple control strategy. In this case, an AI virtual object far away from the player virtual object on an image captured by a camera model has a relatively coarse representation form, and an AI virtual object close to the player virtual object has a relatively fine representation form.

In a possible implementation, the computer device determines, according to a position of a player virtual object in a virtual environment and a virtual environment observed by the player virtual object by a camera model, an AI virtual object located within an observation range of the player virtual object.

Operation 402: Determine a current LOD of the AI virtual object based on at least two levels of LOD determining strategies corresponding to the AI virtual object. Different LOD determining strategies correspond to different LODs. An LOD determining strategy includes at least two determining sub-strategies. Different determining sub-strategies correspond to determining bases in different dimensions. The current LOD is an LOD corresponding to a target LOD determining strategy which the AI virtual object satisfies.

The LOD determining strategy refers to a determining standard for determining whether the AI virtual object is applicable to a control strategy corresponding to a current LOD. Different LODs correspond to different LOD determining strategies. Any level of LOD determining strategy is used for determining whether an LOD corresponding to the AI virtual object is an LOD corresponding to the any level of LOD determining strategy. Each AI virtual object corresponds to at least two levels of LOD determining strategies. Different AI virtual objects may correspond to the same LOD determining strategy or different LOD determining strategies.

In some embodiments, each LOD determining strategy includes at least two determining sub-strategies. Different determining sub-strategies correspond to determining bases of different dimensions. The different dimensions may be embodied in different object attributes of the virtual object. For example, the determining basis may be related to a first object attribute of the AI virtual object, may be related to a second object attribute of the AI virtual object, or may be related to a third object attribute of the AI virtual object. The determining basis may be related to a first object attribute of the player virtual object, may be related to a second object attribute of the player virtual object, etc., which is not limited in embodiments of this application.

The first object attribute, the second object attribute, and the third object attribute of the AI virtual object are three different attributes of the AI virtual object. For example, the first object attribute of the AI virtual object is an object type of the AI virtual object, the second object attribute of the AI virtual object is object coordinates of the AI virtual object, and the third object attribute of the AI virtual object is an object state of the AI virtual object. Certainly, the first object attribute, the second object attribute, and the third object attribute of the AI virtual object may alternatively be attributes in other aspects, such as a body size, an attacked state, and a moving speed of the AI virtual object.

The first object attribute and the second object attribute of the player virtual object are two different attributes of the player virtual object. For example, the first object attribute of the player virtual object is an object type of the player virtual object, and the second object attribute of the player virtual object is an object state of the player virtual object. Certainly, the first object attribute and the second object attribute of the player virtual object may alternatively be attributes in other aspects, such as an attacked state and a moving speed of the player virtual object.

In some embodiments, the computer device may determine the current LOD corresponding to the AI virtual object by determining whether the AI virtual object satisfies the LOD determining strategy corresponding to the current LOD. The AI virtual object corresponds to at least two levels of LOD determining strategies. In cases of different LODs, the computer device may determine, based on the different LOD determining strategies, whether the AI virtual object satisfies the LOD determining strategy corresponding to the current LOD.

In a possible implementation, the computer device may sequentially carry out strategy determining based on an LOD determining strategy in descending order of levels, to determine the current LOD of the AI virtual object. For example, LODs include LOD-0, LOD-1, and LOD-2. The AI virtual object corresponds to third levels of LOD determining strategies such that strategy determining can be performed on the third levels of LODs. The higher the LOD, the more complex processing logic of a corresponding control strategy, and the more an accurate interface representation. The LOD is negatively correlated with an LOD value number, and LOD-0 has a highest LOD. The computer device may determine, from LOD-0, LOD-0 by using an LOD determining strategy corresponding to LOD-0. When an LOD determining strategy corresponding to LOD-0 is determined as an LOD determining strategy which the AI virtual object satisfies, the computer device may determine LOD-0 as the current LOD.

In another possible implementation, the computer device may sequentially carry out strategy determining based on an LOD determining strategy in descending order of levels, to determine the current LOD of the AI virtual object. For example, with an example in which LODs include LOD-0, LOD-1, and LOD-2, the computer device may determine, from LOD-2, LOD-2 by using an LOD determining strategy corresponding to LOD-2. When the LOD determining strategy corresponding to LOD-2 is determined not as the LOD determining strategy which the AI virtual object satisfies. The computer device continues to determine LOD-1 by using the LOD determining strategy corresponding to LOD-1. When the LOD determining strategy corresponding to LOD-1 is determined as the LOD determining strategy which the AI virtual object satisfies, the computer device may determine LOD-1 as the current LOD.

In some embodiments, the computer device may divide LODs according to density of AI virtual objects in a virtual environment and in descending order of the density. A region having higher density corresponds to a higher LOD. Thus, when the LOD determining strategy which the AI virtual object satisfies corresponds to a high LOD, the AI virtual object can have a better representation form in a relatively dense region. In some embodiments, the computer device may further divide LODs according to a distance length by taking the player virtual object as a center. The shorter a distance between the AI virtual object and the player virtual object, the higher the LOD. Thus, an AI virtual object located within a field of view of the player virtual object has a better representation form, and an AI virtual object closer to the player virtual object has a better representation form. A method for dividing LODs is not specifically limited in embodiments of this application.

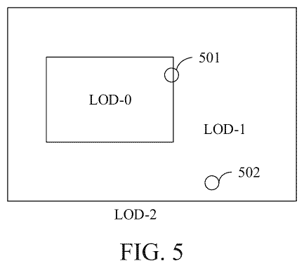

Schematically, as shown in FIG. 5, third LODs, which are LOD-0, LOD-1, and LOD-2 respectively exist. In a case of a first AI virtual object 501, the first AI virtual object 501 corresponds to third levels of LOD determining strategies. The computer device carries out strategy determining on the first AI virtual object 501 based on a 0th-level LOD determining strategy. When the first AI virtual object 501 is determined to satisfy the 0th-level LOD determining strategy, LOD-0 is determined as a current LOD of the first AI virtual object 501. In a case of the second AI virtual object 502, the second AI virtual object 502 corresponds to third levels of LOD determining strategies. The computer device sequentially carries out strategy determining on the second AI virtual object 502 based on the LOD determining strategy in descending order of levels. When the second AI virtual object 502 is determined to satisfy a first-level LOD determining strategy, LOD-1 is determined as a current LOD of the second AI virtual object 502.

Operation 403: Control, based on a control strategy corresponding to the current LOD, the AI virtual object to carry out an activity in a virtual environment. Different LODs correspond to different control strategies.

In some embodiments, different LODs correspond to different control strategies. The higher the LOD, the more complex control logic of a corresponding control strategy, or the higher logic running frequency, or the more complex control logic and the higher logic running frequency, and the higher performance consumption.

In some embodiments, the control strategy may be represented as the AI control logic of the AI virtual object, or may be represented as logic running frequency of the AI control logic of the AI virtual object, or may be represented as both the AI control logic and the logic running frequency of the AI control logic of the AI virtual object, etc., which is not limited in embodiments of this application.

In a possible implementation, after determining the current LOD corresponding to the AI virtual object, the computer device acquires the control strategy corresponding to the current LOD, to control the AI virtual object to carry out an activity in the virtual environment by using the control strategy.

In conclusion, in embodiments of this application, in a case of an AI virtual object located within an observation range of a player virtual object, a current LOD of the AI virtual object is determined based on at least two levels of LOD determining strategies corresponding to the AI virtual object such that the AI virtual object can be controlled according to a control strategy corresponding to the current LOD. Thus, determining standards for determining the LOD of the AI virtual object are enriched, and diversity of strategies for controlling the AI virtual object is increased. Moreover, in embodiments of this application, different LOD determining strategies each include at least two determining sub-strategies. Different determining sub-strategies correspond to determining bases in different dimensions. Relatively rich dimensions are considered in a process of determining an LOD such that reliability of determining an LOD can be improved. Thus, reliability of a control strategy corresponding to an AI virtual object can be improved, unnecessary power consumption can be reduced, and a display effect of the AI virtual object in a virtual scenario can be optimized. Further, visual experience of a player can be improved, and a human-computer interaction rate can be improved.

In a possible implementation, the computer device may sequentially determine, based on a corresponding LOD determining strategy in descending order of LODs, whether the AI virtual object satisfies the LOD determining strategy, to determine a current LOD corresponding to the AI virtual object. Thus, an optimal control strategy applicable to the AI virtual object can be determined, and an optimal representation form of the AI virtual object can be ensured.

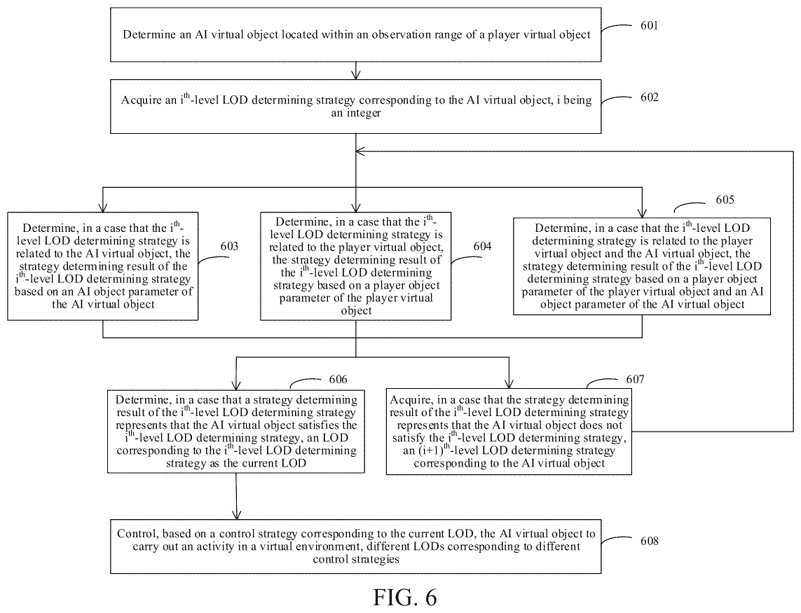

With reference to FIG. 6, a flow diagram of a method for controlling an AI virtual object according to an exemplary embodiment of this application is shown. An example in which the method is executed by a computer device (including a terminal 320 and/or a server 340) shown in FIG. 3 is used for description. The method includes operation 601 to operation 608 as follows:

Operation 601: Determine an AI virtual object located within an observation range of a player virtual object.

Reference can be made to operation 401 for a specific implementation of this operation, which will not be repeated herein in the embodiment.

Operation 602: Acquire an i^{th}-level LOD determining strategy corresponding to the AI virtual object. Specifically, i is an integer.

In a possible implementation, the computer device sequentially carries out LOD strategy determining in descending order of LODs, to obtain an i^{th}-level LOD determining strategy corresponding to the AI virtual object. The i^{th}-level LOD determining strategy corresponding to the AI virtual object refers to an LOD determining strategy currently required to be determined of at least two levels of LOD determining strategies corresponding to the AI virtual object in a process that determining is carried out sequentially in descending order of levels of the LOD determining strategies. For example, 3 levels of LOD determining strategies are provided, and are sequentially a 1^{st}-level LOD determining strategy, a 2^{nd}-level LOD determining strategy, and a 3^{rd} LOD determining strategy in descending order. In this case, at an initial moment of determining, the i^{th}-level LOD determining strategy is the 1st-level LOD determining strategy. If the AI virtual object is determined to not satisfy the 1st-level LOD determining strategy, the i^{th}-level LOD determining strategy is the 2^{nd}-level LOD determining strategy. If the AI virtual object is determined to not satisfy the 2^{nd}-level LOD determining strategy, the i^{th}-level LOD determining strategy is a 3^{rd}-level LOD determining strategies.

In some embodiments, different AI virtual objects may correspond to different LOD determining strategies, and different LODs may correspond to different LOD determining strategies. Moreover, the LOD determining strategy may be related to the AI virtual object, may be related to the player virtual object, or may be related to both the AI virtual object and the player virtual object, which is not specifically limited in embodiments of this application. In some embodiments, different AI virtual objects may correspond to the same LOD determining strategy.

Operation 603: Determine, when the i^{th}-level LOD determining strategy is related to the AI virtual object, the strategy determining result of the i^{th}-level LOD determining strategy based on an AI object parameter of the AI virtual object.

In some embodiments, the i^{th}-level LOD determining strategy is related to the AI virtual object. In some embodiments, the i^{th}-level LOD determining strategy may be related to an object attribute of the AI virtual object, such as a body size, an attacked state, and a moving speed of the AI virtual object. In some embodiments, the object attribute of the AI virtual object may be referred to as an object parameter of the AI virtual object, an AI object parameter of the AI virtual object, etc.

In a possible implementation, when the i^{th}-level LOD determining strategy is related to the AI virtual object, the computer device acquires an object parameter of the current AI virtual object, carries out LOD strategy determining based on the object parameter of the AI virtual object and the i^{th}-level LOD determining strategy, and obtains a strategy determining result of the i^{th}-level LOD determining strategy. The strategy determining result represents whether the AI virtual object satisfies the i^{th}-level LOD determining strategy.

For example, assuming that an object parameter of a current AI virtual object is a moving speed of 50 m/s, and an i^{th}-level LOD determining strategy is that a moving speed of the AI virtual object is less than 60 m/s, a strategy determining result of the i^{th}-level LOD determining strategy is that the AI virtual object satisfies the i^{th}-level LOD determining strategy. For another example, assuming that an object parameter of a current AI virtual object is severely attacked, and an i^{th}-level LOD determining strategy is that the AI virtual object is not attacked, a strategy determining result of the i^{th}-level LOD determining strategy is that the AI virtual object does not satisfy the i^{th}-level LOD determining strategy.

The expression that the i^{th}-level LOD determining strategy is related to the AI virtual object involved in operation 603 means that the i^{th}-level LOD determining strategy is related to the AI virtual object, and the i^{th}-level LOD determining strategy is not related to the player virtual object.

Operation 604: Determine, when the i^{th}-level LOD determining strategy is related to the player virtual object, the strategy determining result of the i^{th}-level LOD determining strategy based on a player object parameter of the player virtual object.

In some embodiments, the i^{th}-level LOD determining strategy is related to the player virtual object. In some embodiments, the i^{th}-level LOD determining strategy may be related to an object attribute of the player virtual object, such as an attacked state or a moving speed of the player virtual object. In some embodiments, the object attribute of the player virtual object may be referred to as an object parameter of the player virtual object, a player object parameter of the player virtual object, etc.

In a possible implementation, when the i^{th}-level LOD determining strategy is related to the player virtual object, the computer device acquires an object parameter of the current player virtual object, carries out LOD strategy determining based on the object parameter of the player virtual object and the i^{th}-level LOD determining strategy, and obtains a strategy determining result of the i^{th}-level LOD determining strategy. The strategy determining result represents whether the AI virtual object satisfies the i^{th}-level LOD determining strategy.

For example, assuming that an object parameter of a player virtual object is a moving speed of 100 m/s, and an i^{th}-level LOD determining strategy is that a moving speed of the player virtual object is less than 80 m/s, a strategy determining result of the i^{th}-level LOD determining strategy is that the AI virtual object does not satisfy the i^{th}-level LOD determining strategy. For another example, assuming that an object parameter of a current player virtual object is not be attacked, and an i^{th}-level LOD determining strategy is that the player virtual object is not attacked, a strategy determining result of the i^{th}-level LOD determining strategy is that the AI virtual object satisfies the i^{th}-level LOD determining strategy.

The expression that the i^{th}-level LOD determining strategy is related to the player virtual object involved in operation 604 means that the i^{th}-level LOD determining strategy is related to the player virtual object, and the i^{th}-level LOD determining strategy is not related to the AI virtual object.

Operation 605: Determine, when the i^{th}-level LOD determining strategy is related to the player virtual object and the AI virtual object, the strategy determining result of the i^{th}-level LOD determining strategy based on a player object parameter of the player virtual object and an AI object parameter of the AI virtual object.

In some embodiments, the i^{th}-level LOD determining strategy is related to the player virtual object and the AI virtual object. In some embodiments, the i^{th}-level LOD determining strategy is related to an object attribute of the player virtual object and an object attribute of the AI virtual object.

In a possible implementation, when the i^{th}-level LOD determining strategy is related to the player virtual object and the AI virtual object, the computer device acquires an object parameter of the current player virtual object and an object parameter of the AI virtual object, carries out LOD strategy determining based on the i^{th}-level LOD determining strategy, and obtains a strategy determining result of the i^{th}-level LOD determining strategy. The strategy determining result represents whether the AI virtual object satisfies the i^{th}-level LOD determining strategy.

Operation 606: Determine, when a strategy determining result of the i^{th}-level LOD determining strategy represents that the AI virtual object satisfies the i^{th}-level LOD determining strategy, an LOD corresponding to the i^{th}-level LOD determining strategy as the current LOD.

In a possible implementation, a strategy determining result of an i^{th}-level LOD determining strategy represents that the AI virtual object satisfies the i^{th}-level LOD determining strategy, the computer device determines the i^{th} LOD (that is, an LOD corresponding to the i^{th}-level LOD determining strategy) as the current LOD.

Operation 607: Acquire, when the strategy determining result of the i^{th}-level LOD determining strategy represents that the AI virtual object does not satisfy the i^{th}-level LOD determining strategy, an (i+1)^{th}-level LOD determining strategy corresponding to the AI virtual object.

In a possible implementation, when a strategy determining result of the i^{th}-level LOD determining strategy represents that the AI virtual object does not satisfy the i^{th}-level LOD determining strategy, the computer device may continue to acquire an (i+1)^{th}-level LOD determining strategy corresponding to the AI virtual object in descending order of LODs, carry out LOD strategy determining, and continue to determine whether an (i+1)^{th} LOD is the current LOD according to a strategy determining result of the (i+1)^{th}-level LOD determining strategy. The rest can be done in the same manner until the current LOD is determined, or until all LOD determining strategies are traversed and the AI virtual object does not satisfy any LOD determining strategy.

When the current LOD is determined, operation 608 is executed. In cases that all LOD determining strategies are traversed and the AI virtual object does not satisfy any LOD determining strategy, the AI virtual object may be controlled by using default control logic, or a default LOD may serve as a current LOD, and then operation 608 is executed. The default control logic refers to default logic for controlling the AI virtual object, and the default LOD refers to a default LOD of the AI virtual object. The default control logic and the default LOD may be preset by a skilled person, which is not limited in embodiments of this application.

Since the (i+1)^{th}-level LOD determining strategy is an LOD determining strategy that continues to be obtained in descending order of LODs when the AI virtual object does not satisfy the i^{th}-level LOD determining strategy, an LOD corresponding to the i^{th}-level LOD determining strategy is higher than an LOD corresponding to the (i+1)^{th}-level LOD determining strategy.

Operation 608: Control, based on a control strategy corresponding to the current LOD, the AI virtual object to carry out an activity in a virtual environment. Different LODs correspond to different control strategies.

In some embodiments, the control strategy corresponding to the current LOD includes at least one of a target AI control logic and a target logic running frequency. The target AI control logic refers to AI control logic corresponding to the current LOD, and the target logic running frequency is a logic running frequency corresponding to the current LOD. Different LODs correspond to different AI control logic, and complexity of the AI control logic is positively correlated with the LOD. That is, the higher the LOD, the higher the complexity of the corresponding AI control logic. Different LODs correspond to different logic running frequencies, and the logic running frequency is positively correlated with the LOD. That is, the higher the LOD, the higher the corresponding AI logic running frequency.

In a possible implementation, the control strategy may be represented as AI control logic of the AI virtual object. After determining the current LOD, the computer device determines the target AI control logic corresponding to the current LOD. The complexity of the AI control logic is positively correlated with the LOD. The higher the LOD (the less the LOD value), the higher the complexity of the corresponding AI control logic. Further, the computer device controls, based on the target AI control logic, the AI virtual object to carry out an activity in the virtual environment. For example, the computer device runs the target AI control logic based on a default logic running frequency, and controls the AI virtual object to carry out an activity in the virtual environment. The default logic running frequency refers to a default frequency of running the AI control logic. The default logic running frequency may be preset by a skilled person, which is not limited in embodiments of this application.

In a possible implementation, the control strategy may be represented as a logic running frequency of AI control logic of the AI virtual object. After determining the current LOD, the computer device determines the target logic running frequency corresponding to the current LOD. The logic running frequency is positively correlated with the LOD. The higher the LOD (the less the LOD value), the higher the corresponding logic running frequency. Further, the computer device runs the default AI control logic based on the target logic running frequency, and controls the AI virtual object to carry out an activity in the virtual environment.

In a possible implementation, the control strategy may be represented as AI control logic of the AI virtual object and a logic running frequency of the AI control logic. After determining the current LOD, the computer device determines a target AI control logic corresponding to the current LOD and a target logic running frequency of the target AI control logic. Further, the computer device controls, based on the target AI control logic and the target logic running frequency corresponding to the target AI control logic, the AI virtual object to carry out an activity in the virtual environment. For example, the computer device runs the target AI control logic based on a target logic running frequency, and controls the AI virtual object to carry out an activity in the virtual environment.

In the above embodiments, strategy determining is carried out based on the LOD determining strategy corresponding to the AI virtual object in descending order of LODs. Thus, the AI virtual object is ensured to correspond to an optimal LOD, and the AI virtual object is controlled by using an optimal control strategy. Moreover, the LOD determining strategy may be related to the player virtual object, the AI virtual object, or both the player virtual object and the AI virtual object. Thus, diversity of the LOD determining strategies is increased.

In addition, different LODs correspond to different control strategies, and a representation form of the control strategy may be the AI control logic, or may be a logic running frequency of the AI control logic. Thus, diversity of control strategies for controlling the AI virtual object is enriched, and a display effect of the AI virtual object in a virtual scenario can be improved. Further, visual experience of a player can be improved, and a human-computer interaction rate can be improved.

In a possible implementation, the i^{th}-level LOD determining strategy is related to the player virtual object and the AI virtual object. Moreover, the i^{th}-level LOD determining strategy includes a distance determining strategy. That is, the computer device carries out LOD strategy determining according to a distance between the player virtual object and the AI virtual object.

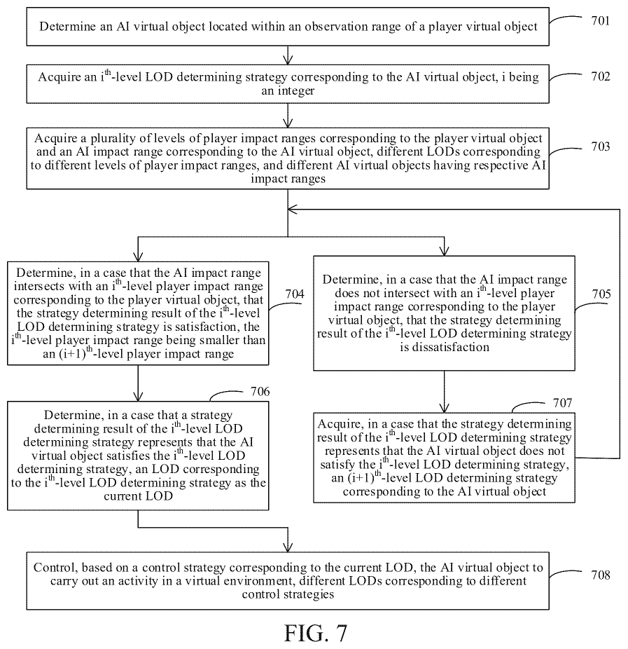

With reference to FIG. 7, a flow diagram of a method for controlling an AI virtual object according to an exemplary embodiment of this application is shown. An example in which the method is executed by a computer device (including a terminal 320 and/or a server 340) shown in FIG. 3 is used for description. The method includes operation 701 to operation 708 as follows:

Operation 701: Determine an AI virtual object located within an observation range of a player virtual object.

Operation 702: Acquire an i^{th}-level LOD determining strategy corresponding to the AI virtual object. Specifically, i is an integer.

Reference can be made to operation 601 and operation 602 for specific implementations of operation 701 and operation 702, which will not be repeated herein in the embodiment.

Operation 703: Acquire a plurality of levels of player impact ranges corresponding to the player virtual object and an AI impact range corresponding to the AI virtual object. Different LODs correspond to different levels of player impact ranges. Different AI virtual objects have respective AI impact ranges.

In embodiments of this application, the player object parameter includes a plurality of levels of player impact ranges corresponding to the player virtual object, and different player impact ranges correspond to different LODs. The AI object parameter includes an AI impact range corresponding to the AI virtual object. In some embodiments, the player impact range is an impact range generated by taking the player virtual object as a center, and different player impact ranges have different sizes. In some embodiments, the size of the player impact range may be preset. Moreover, a plurality of different distance levels may be further preset according to a distance determining strategy. For example, by taking a player virtual object as a center, a circle having a radius of 100 is a first distance level, a circle having a radius of 400 is a second distance level, and a circle having a radius of 500 is a third distance level.

In some embodiments, different levels of player impact ranges correspond to different LODs. For example, according to a distance determining strategy, an LOD may correspond to a distance level. That is, by taking a player virtual object as a center, a first distance level corresponds to LOD-0, a second distance level corresponds to LOD-1, and a third distance level corresponds to LOD-2.

In some embodiments, the AI impact range is an impact range generated by taking the AI virtual object as a center. Different AI virtual objects have respective AI impact ranges. The AI impact ranges may have different sizes. In some embodiments, different AI virtual objects may have the same AI impact range. In some embodiments, the size of the AI impact range may be a preset fixed size, or may be a preset size that can be dynamically changed based on an object attribute of the AI virtual object. For example, the size of the AI impact range may be positively correlated with a body size of the AI virtual object, or may be positively correlated with a life value of the AI virtual object, which is not limited in embodiments of this application.

Different from the related technology that a player virtual object and an AI virtual object are both considered as particles in a virtual scenario, and a distance between the two particles represents a position relationship between the player virtual object and the AI virtual object. In embodiments of this application, in a process of carrying out strategy determining by using a distance determining strategy, an AI impact range of the AI virtual object may be set to be related to a body size of the AI virtual object. For example, the greater the body size of the AI virtual object, the greater the AI impact range. Thus, an AI virtual object having a smaller body size can correspond to AI control logic having high complexity or a high running frequency when the AI virtual object is closer to the player virtual object. When an AI virtual object having a relatively large body size is far away from a player virtual object, since an AI impact range is relatively large, the AI virtual object can also correspond to AI control logic having high complexity or a high running frequency.

In a possible implementation, the player impact range and the AI impact range are two-dimensional plane ranges. The player impact range may be a circle. The AI impact range may be any one of a circle, a trapezoid, and a square.

In a possible implementation, the player impact range and the AI impact range are three-dimensional ranges. The player impact range may be a sphere. The AI impact range is any one of a sphere, a view frustum, and a cube.

In a possible implementation, the computer device acquires a plurality of levels of player impact ranges corresponding to the player virtual object. The plurality of levels of player impact ranges correspond to different LODs respectively. Moreover, the computer device acquires an AI impact range correspond to the AI virtual object, and different AI virtual objects correspond to different AI impact ranges.

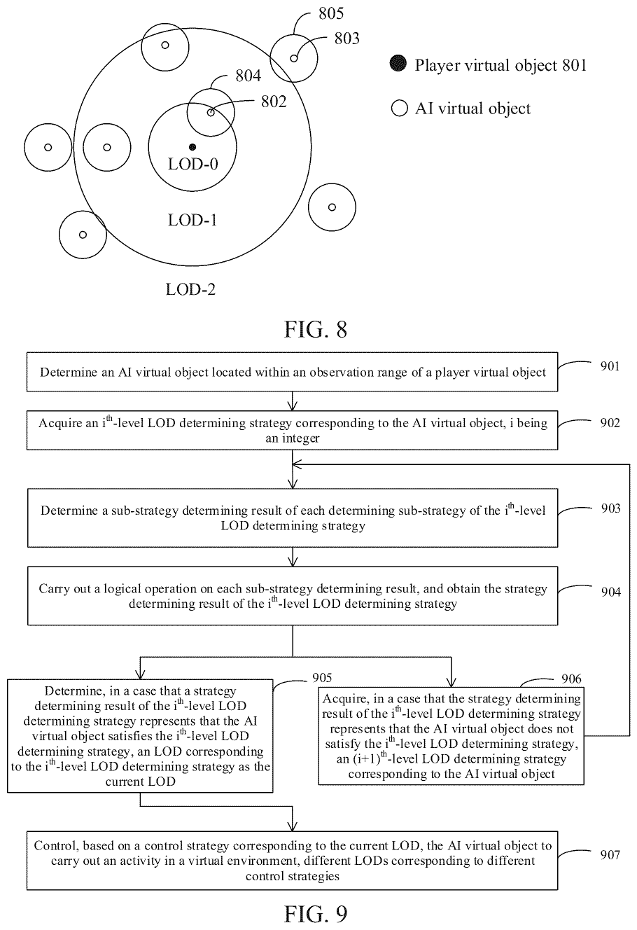

Schematically, as shown in FIG. 8, when the AI impact range and the player impact range are both circles, with a first AI virtual object 802 and a second AI virtual object 803 as an example, the player virtual object 801 corresponds to three levels of player impact ranges. The three levels of player impact ranges correspond to LOD-0, LOD-1, and LOD-2 respectively. The first AI virtual object 802 corresponds to a first AI impact range 804. The second AI virtual object 803 corresponds to a second AI impact range 805.

Operation 704: Determine, when the AI impact range intersects with an i^{th}-level player impact range corresponding to the player virtual object, that the strategy determining result of the i^{th}-level LOD determining strategy is satisfaction. The i^{th}-level player impact range is smaller than an (i+1)^{th}-level player impact range.

In a possible implementation, the computer device carries out strategy determining on an LOD corresponding to the AI virtual object by determining whether the AI impact range corresponding to the AI virtual object intersects with a player impact range corresponding to a player virtual object.

In a possible implementation, since relatively plenty of AI virtual objects generally exist in an open-world game, an AI virtual object relatively far away from the player virtual object can correspond to a relatively low LOD. Thus, performance overhead can be reduced as much as possible while an AI virtual object relatively close to the player virtual object can be ensured to have a relatively excellent representation form. The computer device may divide levels of player impact ranges according to distance levels, and make an i^{th}-level player impact range smaller than an (i+1)^{th}-level player impact range, and an LOD corresponding to the i^{th}-level player impact range higher than an LOD corresponding to the (i+1)^{th}-level player impact range. That is, the higher the LOD (the less the LOD value), the smaller the corresponding player impact range.

In a possible implementation, the computer device sequentially carries out LOD strategy determining based on the LOD determining strategy in descending order of LODs. When the AI impact range intersects with the i^{th}-level player impact range corresponding to the player virtual object, the computer device determines that the strategy determining result of the i^{th}-level LOD determining strategy is satisfaction. That is, the AI virtual object is determined to satisfy the i^{th}-level LOD determining strategy. Thus, an LOD corresponding to the i^{th}-level LOD determining strategy can be determined as the current LOD of the AI virtual object.

Schematically, as shown in FIG. 8, in a case of a first AI virtual object 802, the computer device determines, based on a first AI impact range 804, from a 0th-level player impact range corresponding to LOD-0, whether the first AI impact range 804 intersects with the 0^{th}-level player impact range. When the first AI impact range 804 intersects with the 0^{th}-level player impact range, the computer device determines that a strategy determining result of the 0^{th}-level LOD determining strategy is satisfaction. That is, a current LOD of the first AI virtual object 802 is LOD-0.

Operation 705: Determine, when the AI impact range intersects with the i^{th}-level player impact range corresponding to the player virtual object, that the strategy determining result of the i^{th}-level LOD determining strategy is dissatisfaction.

In a possible implementation, when the AI impact range does not intersect with the i^{th}-level player impact range corresponding to the player virtual object, the computer device determines that the strategy determining result of the i^{th}-level LOD determining strategy is dissatisfaction. That is, the AI virtual object is determined to not satisfy an i^{th}-level LOD determining strategy.

Schematically, as shown in FIG. 8, in a case of a second AI virtual object 803, the computer device determines, based on a second AI impact range 805, from a 0^{th}-level player impact range corresponding to LOD-0, whether the second AI impact range 805 intersects with the 0^{th}-level player impact range. When the second AI impact range 805 does not intersect with the 0^{th}-level player impact range, the computer device determines that a strategy determining result of the 0^{th}-level LOD determining strategy is dissatisfaction, and continues to determine whether the second AI impact range 805 intersects with the 1^{st}-level player impact range. When the second AI impact range 805 intersects with the 1st-level player impact range, the computer device determines that the strategy determining result of the 1^{st}-level LOD determining strategy is satisfaction. That is, a current LOD of the second AI virtual object 803 is LOD-1.

Operation 706: Determine, when a strategy determining result of the i^{th}-level LOD determining strategy represents that the AI virtual object satisfies the i^{th}-level LOD determining strategy, an LOD corresponding to the i^{th}-level LOD determining strategy as the current LOD.

Operation 707: Acquire, when the strategy determining result of the i^{th}-level LOD determining strategy represents that the AI virtual object does not satisfy the i^{th}-level LOD determining strategy, an (i+1)^{th}-level LOD determining strategy corresponding to the AI virtual object.

Operation 708: Control, based on a control strategy corresponding to the current LOD, the AI virtual object to carry out an activity in a virtual environment. Different LODs correspond to different control strategies.

Reference can be made to operation 606 to operation 608 for specific implementations of operation 706 to operation 708, which will not be repeated herein in the embodiment.

In the above embodiment, when the i^{th}-level LOD determining strategy includes a distance determining strategy, player impact ranges are divided by taking the player virtual object as a center. Each player impact range corresponds to each LOD. Whether the AI virtual object satisfies the LOD determining strategy is determined according to whether the AI impact range intersects with the player impact range. Thus, the current LOD of the AI virtual object is determined. An AI virtual object relatively close to the player virtual object has a relatively complex control strategy. An AI virtual object relatively far away from the player virtual object has a relatively simple control strategy. Performance overhead is reduced while a control effect on the AI virtual object is ensured.

In a possible implementation, the computer device determines, by determining whether the AI virtual object satisfies a corresponding LOD determining strategy, the current LOD corresponding to the AI virtual object. Considering that a relatively large number of AI virtual objects exist in the open-world game, and different AI virtual objects have different object features, a plurality of determining sub-strategies may be set in the LOD determining strategy, and whether the AI virtual object satisfies the corresponding LOD determining strategy can be more comprehensively determined.

With reference to FIG. 9, a flow diagram of a method for controlling an AI virtual object according to an exemplary embodiment of this application is shown. An example in which the method is executed by a computer device (including a terminal 320 and/or a server 340) shown in FIG. 3 is used for description. The method includes operation 901 to operation 907 as follows:

Operation 901: Determine an AI virtual object located within an observation range of a player virtual object.

Operation 902: Acquire an i^{th}-level LOD determining strategy corresponding to the AI virtual object. Specifically, i is an integer.

Reference can be made to operation 601 and operation 602 for specific implementations of operation 901 and operation 902, which will not be repeated herein in the embodiment.

Operation 903: Determine a sub-strategy determining result of each determining sub-strategy of the i^{th}-level LOD determining strategy.

In a possible implementation, in a case of an i^{th}-level LOD determining strategy including at least two determining sub-strategies, the computer device may sequentially carry out strategy determining on the AI virtual object based on the determining sub-strategies, and determine a sub-strategy determining result of each determining sub-strategy of the i^{th}-level LOD determining strategy.

In some embodiments, different determining sub-strategies correspond to determining bases of different dimensions. In some embodiments, the determining basis may be related to an object attribute of the AI virtual object, may be related to an object attribute of the player virtual object, or may be related to both the AI virtual object and the player virtual object.

In some embodiments, the determining basis may be any one of a distance between the player virtual object and the AI virtual object, a virtual object type of the AI virtual object, a body size of the AI virtual object, a current position of the AI virtual object, whether the player virtual object is currently in an active state, whether the player virtual object moves in a virtual scenario, and whether the player virtual object is in a special state (such as slow movement and vertigo).

In a possible implementation, the computer device may set the determining basis for the determining sub-strategy as a distance between the player virtual object and the AI virtual object, such that an AI virtual object relatively close to the player virtual object corresponds to control logic having high complexity and/or a high logic running frequency, and an AI virtual object relatively far away from the player virtual object corresponds to control logic having low complexity and/or a low logic running frequency. Thus, unnecessary power consumption can be reduced.

In a possible implementation, the computer device may set the determining basis of the determining sub-strategy as a virtual object type of the AI virtual object such that different types of the AI virtual object can be more directly distinguished. Thus, different types of AI virtual objects correspond to control logic having different complexity and/or different logic running frequencies.

In a possible implementation, the computer device may set the determining basis of the determining sub-strategy as a body size of the AI virtual object such that reality of the AI virtual object in the virtual scenario can be improved. For example, an AI virtual object having a relatively small body size acts more flexibly, and an AI virtual object having a relatively large body size acts more slowly. Thus, AI virtual objects having different body sizes correspond to control logic having different complexity and/or different logic running frequencies.

In a possible implementation, the computer device may set the determining basis of the determining sub-strategy as a current position of the AI virtual object such that reality of the AI virtual object in the virtual scenario can be improved. For example, an AI virtual object acting in water has a relatively slow activity, and an AI virtual object acting on the ground has a relatively flexible activity. Thus, AI virtual objects carrying out activities at different positions correspond to control logic having different complexity and/or different logic running frequencies.

In a possible implementation, the computer device may set the determining basis of the determining sub-strategy as whether the player virtual object is currently in an active state such that reality of the AI virtual object in the virtual scenario can be improved. For example, when the player virtual object is in an active state, the AI virtual object within the observation range of the player virtual object requires control logic having high complexity and/or a high logic running frequency, to cooperate with the player virtual object for movement.

In a possible implementation, the computer device may set the determining basis of the determining sub-strategy as whether the player virtual object is in a special state such that different observed states of the AI virtual object are reflected when the player virtual object is in a normal state and in a special state. For example, when the player virtual object is in the normal state, the AI virtual object within the observation range of the player virtual object is also in a normal acting state, that is, corresponds to a control logic having high complexity and/or a high logic running frequency. When the player virtual object is in a vertigo state, the AI virtual object within the observation range of the player virtual object acts relatively slowly, that is, corresponds to control logic having low complexity and/or a low logic running frequency.

In a schematic example, the i^{th}-level LOD determining strategy includes a distance determining strategy and a body size determining strategy of an AI virtual object. The computer device may sequentially carry out strategy determining on the AI virtual object based on the distance determining strategy and the body size determining strategy of the AI virtual object. Thus, a sub-strategy determining result corresponding to the distance determining strategy and a sub-strategy determining result corresponding to the body size determining strategy of the AI virtual object are obtained.

In a schematic example, the i^{th}-level LOD determining strategy includes three determining sub-strategies. the determining basis of a first determining sub-strategy is a current position of the AI virtual object. the determining basis of a second determining sub-strategy is whether the player virtual object is currently in an active state. the determining basis of a third determining sub-strategy is a distance between the AI virtual object and the player virtual object. Thus, the computer device determines, based on an object attribute of the AI virtual object and an object attribute of the player virtual object, that the AI virtual object is currently located on the ground, the player virtual object is currently in an active state, and a distance between the player virtual object and the AI virtual object satisfies a distance threshold. A sub-strategy determining result of each determining sub-strategy represents that the AI virtual object satisfies the determining sub-strategy.

In a schematic example, the i^{th}-level LOD determining strategy includes four determining sub-strategies. A determining basis of a first determining sub-strategy is a body size of the AI virtual object. A determining basis of a second determining sub-strategy is a position of the player virtual object. A determining basis of a third determining sub-strategy is a distance between the AI virtual object and the player virtual object. A determining basis of a fourth determining sub-strategy is a virtual object type of the AI virtual object. Thus, the computer device determines, based on an object attribute of the AI virtual object and an object attribute of the player virtual object, that the AI virtual object has a medium size body, the player virtual object is in the air, a distance between the player virtual object and the AI virtual object satisfies a distance threshold, and the AI virtual object is an attacking-type virtual object. The sub-strategy determining result of each determining sub-strategy represents that the AI virtual object satisfies the determining sub-strategy.

A quantity of determining sub-strategies included in each level of LOD determining strategies, a combination manner of the determining sub-strategies, etc. are not specifically limited in embodiments of this application.

Operation 904: Carry out a logical operation on each sub-strategy determining result, and obtain the strategy determining result of the i^{th}-level LOD determining strategy.

In a possible implementation, after strategy determining is sequentially carried out based on the determining sub-strategies, and the sub-strategy determining results are obtained, and considering that in a plurality of sub-strategy determining results, a sub-strategy determining result representing that the AI virtual object satisfies the determining sub-strategy, and a sub-strategy determining result representing that the AI virtual object does not satisfy the determining sub-strategy may both exist, since different determining sub-strategies may have different weights, and in a case of a sub-strategy determining result having a relatively low weight value, an impact on a final strategy determining result is relatively small, in a case of the sub-strategy determining result of each determining sub-strategy, the computer device may carry out a logical operation on each sub-strategy determining result in a logical operation manner, and obtain a strategy determining result of the i^{th}-level LOD determining strategy.

In a schematic example, the i^{th}-level LOD determining strategy includes a distance determining strategy and a body size determining strategy of an AI virtual object. The computer device may carry out, in a compound logical operation manner according to an intersection set and a union set, “and/or” processing on a sub-strategy determining result corresponding to the distance determining strategy and a sub-strategy determining result corresponding to a body size determining strategy of the AI virtual object. For example, according to a union set principle, as long as one of the sub-strategy determining result corresponding to the distance determining strategy and the sub-strategy determining result corresponding to the body size determining strategy of the AI virtual object represents that the AI virtual object satisfies the determining sub-strategy, a strategy determining result of the i^{th}-level LOD determining strategy is determined to be that the AI virtual object satisfies the i^{th}-level LOD determining strategy. For another example, according to an intersection set principle, when both the sub-strategy determining result corresponding to the distance determining strategy and the sub-strategy determining result corresponding to the body size determining strategy represent that the AI virtual object satisfies the corresponding determining sub-strategy, the computer device determines that the strategy determining result of the i^{th}-level LOD determining strategy is that the AI virtual object satisfies the i^{th}-level LOD determining strategy.

In a schematic example, the i^{th}-level LOD determining strategy includes three determining sub-strategies. A determining basis of a first determining sub-strategy is a current position of the AI virtual object. A determining basis of a second determining sub-strategy is whether the player virtual object is in an active state. A determining basis of a third determining sub-strategy is a distance between the AI virtual object and the player virtual object. If a logical operation manner of the i^{th}-level LOD determining strategy is a union set, when one of sub-strategy determining results corresponding to the three determining sub-strategies represents that the AI virtual object satisfies the determining sub-strategy, a strategy determining result of the i^{th}-level LOD determining strategy is determined to be that the AI virtual object satisfies the i^{th}-level LOD determining strategy. If a logical operation manner of the i^{th}-level LOD determining strategy is an intersection set, when sub-strategy determining results corresponding to the three determining sub-strategies all represent that the AI virtual object satisfies a determining sub-strategy, the computer device determines a strategy determining result of the i^{th}-level LOD determining strategy to be that the AI virtual object satisfies the i^{th}-level LOD determining strategy.

In a schematic example, the i^{th}-level LOD determining strategy may further include four determining sub-strategies. A determining basis of the first determining sub-strategy is a body size of the AI virtual object. A determining basis of the second determining sub-strategy is a position of the player virtual object. A determining basis of the third determining sub-strategy is a distance between the AI virtual object and the player virtual object. A determining basis of the fourth determining sub-strategy is a virtual object type of the AI virtual object. If a logical operation manner of the i^{th}-level LOD determining strategy is a union set, when one of sub-strategy determining results corresponding to the four determining sub-strategies represents that the AI virtual object satisfies the determining sub-strategy, a strategy determining result of the i^{th}-level LOD determining strategy is determined to be that the AI virtual object satisfies the i^{th}-level LOD determining strategy. If a logical operation manner of the i^{th}-level LOD determining strategy is an intersection set, when sub-strategy determining results corresponding to the four determining sub-strategies all represent that the AI virtual object satisfies a determining sub-strategy, the computer device can determine a strategy determining result of the i^{th}-level LOD determining strategy to be that the AI virtual object satisfies the i^{th}-level LOD determining strategy.

In embodiments of this application, a combination manner of determining sub-strategies of each level of LOD determining strategies and logical operation manners corresponding to the LOD determining strategies are not specifically limited.

Operation 905: Determine, when a strategy determining result of the i^{th}-level LOD determining strategy represents that the AI virtual object satisfies the i^{th}-level LOD determining strategy, an LOD corresponding to the i^{th}-level LOD determining strategy as the current LOD.

Operation 906: Acquire, when the strategy determining result of the i^{th}-level LOD determining strategy represents that the AI virtual object does not satisfy the i^{th}-level LOD determining strategy, an (i+1)^{th}-level LOD determining strategy corresponding to the AI virtual object.

Operation 907: Control, based on a control strategy corresponding to the current LOD, the AI virtual object to carry out an activity in a virtual environment. Different LODs correspond to different control strategies.

Reference can be made to operation 606 to operation 608 for specific implementations of operation 905 to operation 907, which will not be repeated herein in the embodiment.

In the above embodiments, in a case of an LOD determining strategy including a plurality of determining sub-strategies, the computer device may first carry out strategy determining on the AI virtual object based on each determining sub-strategy, and obtain a sub-strategy determining result, and then carry out a logical operation on each sub-strategy determining result in a logical operation manner, and obtain a strategy determining result of an i^{th}-level determining strategy. By determining a strategy determining result of the i^{th}-level determining strategy by using sub-strategy determining results corresponding to the plurality of determining sub-strategies, diversity of strategy determining standards is increased.

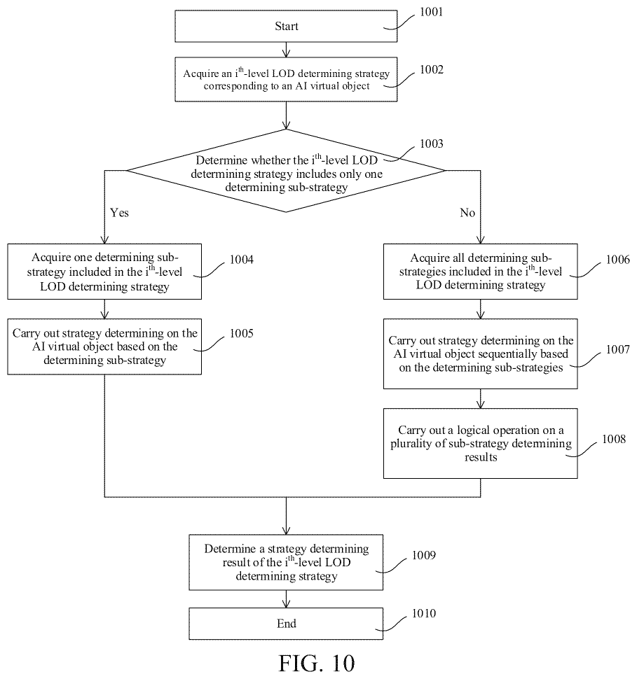

With reference to FIG. 10, a flow diagram of a logical operation of an LOD determining strategy according to an exemplary embodiment of this application is shown.

Operation 1001: Start.

Operation 1002: Acquire an i^{th}-level LOD determining strategy corresponding to the AI virtual object.

The computer device sequentially carries out LOD strategy determining in descending order of LODs, and first acquires an i^{th}-level LOD determining strategy corresponding to the AI virtual object.

Operation 1003: Determine whether the i^{th}-level LOD determining strategy includes only one determining sub-strategy.

The computer device determines whether the i^{th}-level LOD determining strategy includes only one determining sub-strategy. When only one determining sub-strategy is included, operation 1004 is performed. When at least two determining sub-strategies are included, operation 1006 is performed.

Operation 1004: Acquire one determining sub-strategy included in the i^{th}-level LOD determining strategy.

Operation 1005: Carry out strategy determining on the AI virtual object based on a determining sub-strategy.

The computer device carries out LOD strategy determining on the AI virtual object based on a determining sub-strategy, and obtains a sub-strategy determining result corresponding to the determining sub-strategy.

Operation 1006: Acquire all determining sub-strategies included in the i^{th}-level LOD determining strategy.

Operation 1007: Carry out strategy determining on the AI virtual object sequentially based on the determining sub-strategies.

The computer device sequentially carries out strategy determining on the AI virtual object based on each determining sub-strategy, and obtains a sub-strategy determining result corresponding to each determining sub-strategy.

Operation 1008: Carry out a logical operation on a plurality of sub-strategy determining results.

The computer device carries out a compound logical operation on the sub-strategy determining results.

Operation 1009: Determine a strategy determining result of an i^{th}-level LOD determining strategy.

In a case of an i^{th}-level LOD determining strategy including only one determining sub-strategy, the computer device determines a sub-strategy determining result of the determining sub-strategy as a strategy determining result of the i^{th}-level LOD determining strategy. In a case of an i^{th}-level LOD determining strategy including at least two determining sub-strategies, the computer device determines a result obtained after the logical operation as a strategy determining result of the i^{th}-level LOD determining strategy.

Operation 1010: End.

In a possible implementation, considering that in an open-world game, a relatively large number of AI virtual objects exist, and a plurality of AI virtual objects may carry out activities in a virtual environment in a clustering manner, the computer device may control the plurality of AI virtual objects by using the same control strategy, to reduce performance overhead.

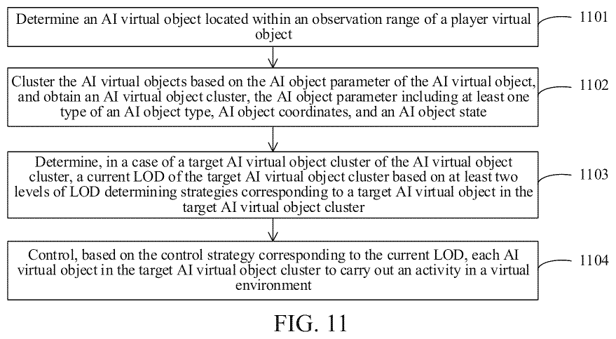

With reference to FIG. 11, a flow diagram of a method for controlling an AI virtual object according to an exemplary embodiment of this application is shown. An example in which the method is executed by a computer device (including a terminal 320 and/or a server 340) shown in FIG. 3 is used for description. The method includes operation 1101 to operation 1104 as follows:

Operation 1101: Determine an AI virtual object located within an observation range of a player virtual object.

Reference can be made to operation 401 for a specific implementation of operation 1101, which will not be repeated herein in the embodiment. In embodiments of this application, a plurality of AI virtual objects are provided.

Operation 1102: Cluster the AI virtual objects based on the AI object parameter of the AI virtual object, and obtain an AI virtual object cluster. The AI object parameter includes at least one type of an AI object type, AI object coordinates, and an AI object state.

In a possible implementation, since an AI virtual objects carrying out activities in a clustering form may exist in an open-world game, the computer device may determine clustering of the AI virtual objects according to the AI object parameter of the AI virtual object, and obtain an AI virtual object cluster. Thus, a current LOD of a target AI virtual object cluster can be directly determined, and performance overhead can be reduced.

In some embodiments, the AI object parameter may include at least one type of an AI object type, AI object coordinates, and an AI object state. That is, the computer device may cluster the AI virtual objects based on at least one type of an AI object type, AI object coordinates, and an AI object state.

In a schematic example, the computer device clusters AI virtual objects according to the AI object type, such as a migration behavior of a sheep flock in a virtual environment. After moving to a new staff site, the sheep flock will carry out activities in a clustering form within a movement range of the staff site, such as roaming, patrolling, and defending against external enemy. For another example, in a case of a hunting behavior of a wolf pack in a virtual environment, the wolf pack moves together at night, and fights against prey. After the fight, the wolf pack continues to execute some individual activities as a unit in a clustering manner, such as patrolling, packing a trophy, and satisfying hunger.

Operation 1103: Determine, in a case of a target AI virtual object cluster of the AI virtual object cluster, a current LOD of the target AI virtual object cluster based on at least two levels of LOD determining strategies corresponding to a target AI virtual object in the target AI virtual object cluster.

In a possible implementation, after the AI virtual objects are clustered, the computer device may determine a target AI virtual object cluster from the AI virtual object clusters, and take a current LOD corresponding to a target AI virtual object in the target AI virtual object cluster as a current LOD of the target AI virtual object cluster, to simplify a process of determining the current LOD of the target AI virtual object cluster. The target AI virtual object cluster is any AI virtual object cluster obtained through clustering in operation 1102.

In a possible implementation, the computer device may determine a central position corresponding to the target AI virtual object cluster based on AI object coordinates of each AI virtual object of the target AI virtual object cluster, and take an AI virtual object, of which AI object coordinates are closest to the central position, of the target AI virtual object cluster as the target AI virtual object. For example, an AI virtual object of which AI object coordinates are located at the central position exist in the target AI virtual object cluster, the computer device may determine the AI virtual object of which AI object coordinates are located at the central position in the target AI virtual object cluster as the target AI virtual object. After determining the target AI virtual object, the computer device may determine the current LOD of the target AI virtual object based on the at least two levels of LOD determining strategies corresponding to the target AI virtual object, and take the current LOD as the current LOD of the target AI virtual object cluster. That is, the current LOD of the target AI virtual object serves as a current LOD of each AI virtual object in the target AI virtual object cluster.

In a possible implementation, when the LOD determining strategy includes the distance determining strategy, the computer device may further determine the target AI impact range of the target AI virtual object cluster based on the AI impact range of each AI virtual object in the target AI virtual object cluster, carry out distance strategy determining based on the target AI impact range and a plurality of levels of player impact ranges of a player virtual object, obtain a strategy determining result of the distance determining strategy, and determine the current LOD of the target AI virtual object cluster based on the strategy determining result.

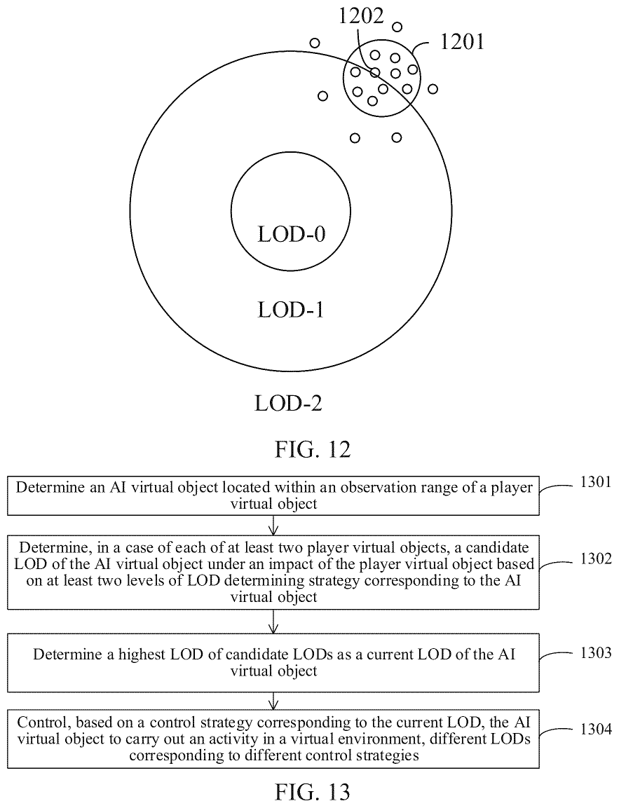

Schematically, as shown in FIG. 12, with an example in which the LOD determining strategy includes a distance determining strategy, the computer device clusters a plurality of AI virtual objects, obtains an AI virtual object cluster, and determines a target AI virtual object cluster 1201 from the AI virtual object cluster. Further, the computer device determines, based on third levels of LOD determining strategies corresponding to the target AI virtual object 1202 in the target AI virtual object cluster 1201, that a current LOD of the target AI virtual object 1202 is LOD-1, and determines that the current LOD of the target AI virtual object cluster 1201 is LOD-1.

Operation 1104: Control, based on the control strategy corresponding to the current LOD, each AI virtual object in the target AI virtual object cluster to carry out an activity in the virtual environment.

Further, the computer device directly controls each AI virtual object in the target AI virtual object cluster by using a control strategy corresponding to the current LOD.

In the above embodiment, the AI virtual objects are clustered according to the AI object parameters of the AI virtual objects. The target AI virtual object cluster is determined from the AI virtual object cluster. The current LOD of the target AI virtual object cluster is determined based on at least two levels of LOD determining strategies corresponding to the target AI virtual object in the target AI virtual object cluster. Thus, each AI virtual object in the target AI virtual object cluster is directly controlled according to the control strategy corresponding to the current LOD. Efficiency of controlling the AI virtual object is improved, and performance overhead is reduced.

In a possible implementation, in an open-world game, a plurality of player virtual objects mostly exist. That is, an AI virtual object may be located within an observation range of a plurality of player virtual objects. When an LOD determining strategy is related to a player virtual object, the computer device may sequentially carry out LOD strategy determining based on each player virtual object, and determine a candidate LOD having a highest LOD (a smallest LOD number) as a current LOD.

With reference to FIG. 13, a flow diagram of a method for controlling an AI virtual object according to an exemplary embodiment of this application is shown. An example in which the method is executed by a computer device (including a terminal 320 and/or a server 340) shown in FIG. 3 is used for description. The method includes:

Operation 1301: Determine an AI virtual object located within an observation range of a player virtual object.

Reference can be made to operation 401 for a specific implementation of operation 1301, which will not be repeated herein in the embodiment.

Operation 1302: Determine, in a case of each of the at least two player virtual objects, a candidate LOD of the AI virtual object under an impact of the player virtual object based on the at least two levels of LOD determining strategy corresponding to the AI virtual object.

In a possible implementation, the computer device sequentially acquires, in a case of each of the at least two player virtual objects, an object parameter of each player virtual object, and determines, based on at least two levels of LOD determining strategies corresponding to the AI virtual object, a candidate LOD of the AI virtual object under an impact of each player virtual object.

In a schematic example, the LOD determining strategy is a distance determining strategy. The computer device acquires a plurality of levels of player impact ranges corresponding to each player virtual object, sequentially carries out strategy determining on the AI virtual object based on the plurality of levels of player impact ranges corresponding to each player virtual object and the AI impact range of the AI virtual object, and obtains a plurality of candidate LODs of the AI virtual object.

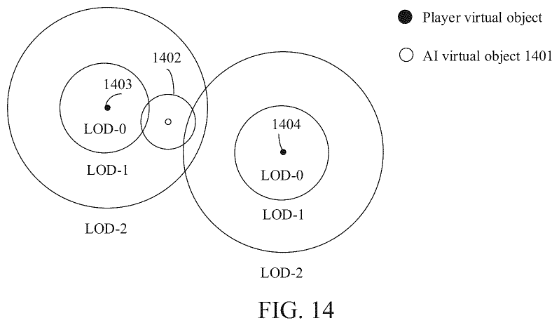

Schematically, as shown in FIG. 14, with an example in which the LOD determining strategy is a distance determining strategy, an AI virtual object 1401 corresponds to an AI impact range 1402. A first player virtual object 1403 and a second player virtual object 1404 each correspond to three levels of player impact ranges. The three levels of player impact ranges correspond to LOD-0, LOD-1, and LOD-2 respectively. In a case of the first player virtual object 1403, the computer device determines, based on third levels of distance determining strategies corresponding to the AI virtual object 1401, a first candidate LOD corresponding to the AI virtual object 1401 as LOD-0. In a case of the second player virtual object 1404, the computer device determines, based on third levels of distance determining strategies corresponding to the AI virtual object 1401, a second candidate LOD corresponding to the AI virtual object 1401 as LOD-1.

Operation 1303: Determine a highest LOD of candidate LODs as the current LOD of the AI virtual object.

In a possible implementation, the computer device may determine, from the candidate LODs, an LOD having a highest LOD as the current LOD of the AI virtual object, to ensure the AI virtual object to have an excellent performance effect.

Schematically, as shown in FIG. 14, the computer device determines that a first candidate LOD corresponding to the AI virtual object 1401 is LOD-0 and a second candidate LOD corresponding to the AI virtual object 1401 is LOD-1. Since the level of LOD-1 is higher than that of LOD-1, the computer device determines a current LOD of the AI virtual object 1401 as LOD-1.

Operation 1304: Control, based on a control strategy corresponding to the current LOD, the AI virtual object to carry out an activity in a virtual environment. Different LODs correspond to different control strategies.

Reference can be made to operation 608 for a specific implementation of operation 1304, which will not be repeated herein in the embodiment.

In the above embodiments, when an LOD determining strategy is related to a player virtual object, for AI virtual objects located within observation ranges of a plurality of player virtual objects, strategy determining is sequentially carried out on the AI virtual objects based on the LOD determining strategies of the AI virtual objects, and candidate LODs are obtained. Then, an AI virtual object having a highest level is determined from the candidate LODs as a current LOD of the AI virtual object. Complexity of a control strategy of the AI virtual object is improved, and a representation form of the AI virtual object is ensured.

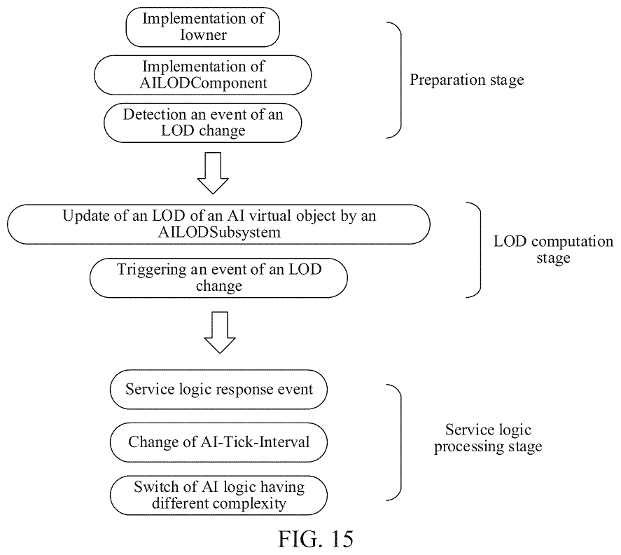

With reference to FIG. 15, three stages of determining a control strategy for an AI virtual object according to an exemplary embodiment of this application are shown.

As shown in FIG. 15, a preparation stage includes implementation of IOwner, implementation of a AILOD component, and detection of an event of an LOD change. An LOD computation stage includes: update of an LOD of the AI virtual object by an AILODSubsystem, and triggering of an event of an LOD change. A service logic processing stage includes: a service logic response event, a change of a logic running frequency (AI-Tick-Interval), and a switch of AI control logic having different complexity.

LOD (Level of Details): a level of picture fineness or logical complexity in a game. AILOD: an LOD for an AI virtual object.

Firstly, in a preparation stage, the AI virtual object inherits an IOwner interface such that logic at a host level can be implemented. The IOwner interface is mainly configured to transfer information about a host to an AILOD-related component.

The AI virtual object inherits an AILODComponent interface such that an AILODComponent can be implemented. The AILODComponent contains a customized LOD determining strategy.

An event of an LOD change is detected such that a response can be made when the LOD changes. When a program runs, all AILOD components are registered to an AILODSubsystem component. The AILODSubsystem component is configured to manage the AILOD component.

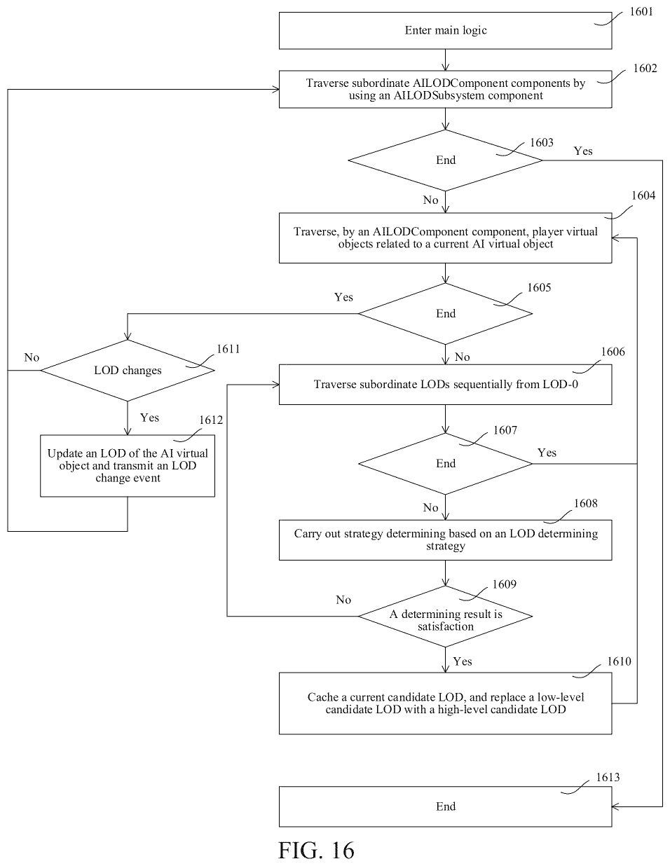

Secondly, the LOD computation stage is shown in FIG. 16. FIG. 16 shows a flow diagram of a method for controlling an AI virtual object according to an exemplary embodiment of this application. An example in which the method is executed by the server 340 shown in FIG. 3 is used for description, the method includes:

Operation 1601: Enter main logic.

When the LOD determining strategy is related to at least the player virtual object, the following operations are executed from a Tick (clock cycle) of main logic of the game program.

Operation 1602: Traverse subordinate AILODComponent components by using an AILODSubsystem component.

The subordinate AILODComponent components are traversed by using the AILODSubsystem component. The AILODComponent components are also components of AI virtual objects, and correspond to the AI virtual objects in a one-to-one manner.

Operation 1603: Determine whether all AILODComponent components are traversed.

If all the AILODComponent components are traversed, operation 1613 is executed. If not, operation 1604 is executed.

Operation 1604: Traverse, by an AILODComponent component, player virtual objects related to the current AI virtual object.

The currently traversed AILODComponent components traverse player virtual objects related to the current AI virtual object.

Operation 1605: Determine whether all player virtual objects are traversed.

If all player virtual objects are traversed, operation 1611 is executed. If not, operation 1606 is executed.

Operation 1606: Traverse subordinate LODs sequentially from LOD-0.

One player virtual object corresponds to a plurality of LODs. The LODs are LOD-0, LOD-1, LOD-2, etc. respectively. From LOD-0, an LOD corresponding to a current player virtual object is traversed.

Operation 1607: Determine whether all LODs are traversed.

If all LODs are traversed, operation 1604 is executed. If not, operation 1608 is executed.

Operation 1608: Carry out strategy determining based on the LOD determining strategy.

LOD strategy determining is sequentially carried out on the AI virtual object according to an LOD determining strategy corresponding to each level, and a strategy determining result is obtained.

Operation 1609: Determine whether a strategy determining result is satisfaction.

If a strategy determining result is yes, operation 1610 is executed. If not, operation 1606 is executed.

Operation 1610: Cache a current candidate LOD, and replace a low-level candidate LOD with a high-level candidate LOD.

When a strategy determining result is satisfaction, the current LOD is determined as a candidate LOD of the AI virtual object. Operation 1604 is returned. Other player virtual objects related to the AI virtual object are continued to be traversed. Other candidate LODs are determined. A highest level of all the candidate LODs is determined as the current LOD.

Operation 1611: Determine whether the LOD changes.

If the LOD changes, operation 1612 is executed. If not, operation 1602 is executed.

Operation 1612: Update an LOD of the AI virtual object and transmit an LOD change event.

When the LOD changes, the LOD of the AI virtual object is updated. Moreover, an LOD change event is sent, and the LOD of the AI virtual object in the virtual environment is changed.

Operation 1613: End.

Finally, at a service logic processing stage, in service logic of a game, since an event of an LOD change is detected, when the LOD changes, the event will be received. The event will transmit values before and after LOD update. A service logic side carries out corresponding processing according to the two values. Before a switch of a low LOD and a high LOD, some preparation work for the switch may be executed. Then, a switch is performed to service logic of a specified LOD according to a changed LOD. A switching result may be a change of a time interval of Agent-AI Tick (such as a change of a logic running frequency of AI control logic of the AI virtual object). Alternatively, a switch may be performed to AI logic having different complexity (such as AI control logic having different complexity) such that performance consumption can be changed.

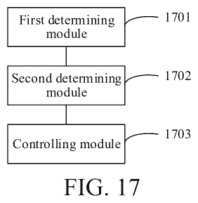

With reference to FIG. 17, a structural block diagram of an apparatus for controlling an AI virtual object according to an exemplary embodiment of this application is shown. The apparatus includes:
a first determining module 1701 configured to determine an AI virtual object located within an observation range of a player virtual object;
a second determining module 1702 configured to determine a current LOD of the AI virtual object based on at least two levels of LOD determining strategies corresponding to the AI virtual object, different LOD determining strategies corresponding to different LODs, an LOD determining strategy including at least two determining sub-strategies, different determining sub-strategies corresponding to determining bases in different dimensions, and the current LOD being an LOD corresponding to a target LOD determining strategy which the AI virtual object satisfies; and
a controlling module 1703 configured to control, based on a control strategy corresponding to the current LOD, the AI virtual object to carry out an activity in a virtual environment, different LODs corresponding to different control strategies.

In some embodiments, the second determining module 1702 is configured to:
acquire an i^{th}-level LOD determining strategy corresponding to the AI virtual object, i being an integer; and
determine, when a strategy determining result of the i^{th}-level LOD determining strategy represents that the AI virtual object satisfies the i^{th}-level LOD determining strategy, an LOD corresponding to the i^{th}-level LOD determining strategy as the current LOD.

In some embodiments, the second determining module 1702 is further configured to acquire, when the strategy determining result of the i^{th}-level LOD determining strategy represents that the AI virtual object does not satisfy the i^{th}-level LOD determining strategy, an (i+1)^{th}-level LOD determining strategy corresponding to the AI virtual object.

In some embodiments, the LOD corresponding to the i^{th}-level LOD determining strategy is higher than an LOD corresponding to the (i+1)^{th}-level LOD determining strategy.

In some embodiments, the apparatus further includes:
a first result determining module configured to determine, when the i^{th}-level LOD determining strategy is related to the AI virtual object, the strategy determining result of the i^{th}-level LOD determining strategy based on an AI object parameter of the AI virtual object;
a second result determining module configured to determine, when the i^{th}-level LOD determining strategy is related to the player virtual object, the strategy determining result of the i^{th}-level LOD determining strategy based on a player object parameter of the player virtual object; and
a third result determining module configured to determine, when the i^{th}-level LOD determining strategy is related to the player virtual object and the AI virtual object, the strategy determining result of the i^{th}-level LOD determining strategy based on a player object parameter of the player virtual object and an AI object parameter of the AI virtual object.

In some embodiments, the i^{th}-level LOD determining strategy is related to the player virtual object and the AI virtual object. The player object parameter includes a plurality of levels of player impact ranges corresponding to the player virtual object. Different player impact ranges correspond to different LODs. The AI object parameter includes an AI impact range corresponding to the AI virtual object.

The third result determining module is configured to:
determine, when the AI impact range intersects with an i^{th}-level player impact range corresponding to the player virtual object, that the strategy determining result of the i^{th}-level LOD determining strategy is satisfaction, the i^{th}-level player impact range being smaller than an (i+1)^{th}-level player impact range; or
determine, when the AI impact range does not intersect with an i^{th}-level player impact range corresponding to the player virtual object, that the strategy determining result of the i^{th}-level LOD determining strategy is dissatisfaction.

In some embodiments, the player impact range and the AI impact range are two-dimensional plane ranges. The player impact range is a circle. The AI impact range is any one of a circle, a trapezoid, and a square.

The player impact range and the AI impact range are three-dimensional ranges. The player impact range is a sphere. The AI impact range is any one of a sphere, a view frustum, and a cube.

In some embodiments, the apparatus further includes:
a fourth result determining module configured to determine a sub-strategy determining result of each determining sub-strategy of the ih-level LOD determining strategy; and carry out a logical operation on each sub-strategy determining result, and obtain the strategy determining result of the i^{th}-level LOD determining strategy.

In some embodiments, a plurality of AI virtual objects are provided. The apparatus further includes:
a clustering module configured to cluster the AI virtual objects based on the AI object parameter of the AI virtual object, and obtain an AI virtual object cluster, the AI object parameter including at least one type of an AI object type, AI object coordinates, and an AI object state.

The second determining module 1702 is configured to: determine, in a case of a target AI virtual object cluster of the AI virtual object cluster, a current LOD of the target AI virtual object cluster based on at least two levels of LOD determining strategies corresponding to a target AI virtual object in the target AI virtual object cluster.

The controlling module 1703 is configured to: control, based on the control strategy corresponding to the current LOD, each AI virtual object in the target AI virtual object cluster to carry out an activity in the virtual environment.

In some embodiments, the second determining module 1702 is further configured to determine a central position corresponding to the target AI virtual object cluster based on AI object coordinates of each AI virtual object in the target AI virtual object cluster; and take an AI virtual object, of which AI object coordinates are closest to the central position, in the target AI virtual object cluster as the target AI virtual object.

In some embodiments, the LOD determining strategy is related to at least the player virtual object. At least two player virtual objects exist in the virtual environment.

The second determining module 1702 is configured to:
determine, in a case of each of the at least two player virtual objects, a candidate LOD of the AI virtual object under an impact of the player virtual object based on the at least two levels of LOD determining strategy corresponding to the AI virtual object; and
determine a highest LOD of candidate LODs as the current LOD of the AI virtual object.

In some embodiments, the control strategy corresponding to the current LOD includes at least one of a target AI control logic and a target logic running frequency. Complexity of the AI control logic is positively correlated with an LOD. The logic running frequency is positively correlated with an LOD.

In some embodiments, the control strategy corresponding to the current LOD includes a target AI control logic. The controlling module 1703 is configured to run the target AI control logic based on a default logic running frequency, and control the AI virtual object to carry out an activity in the virtual environment.

In some embodiments, the control strategy corresponding to the current LOD includes a target logic running frequency. The controlling module 1703 is configured to run a default AI control logic based on the target logic running frequency, and control the AI virtual object to carry out an activity in the virtual environment.

In some embodiments, the control strategy corresponding to the current LOD includes a target AI control logic and a target logic running frequency. The controlling module 1703 is configured to run the target AI control logic based on the target logic running frequency, and control the AI virtual object to carry out an activity in the virtual environment.

In some embodiments, the determining basis includes any one of a distance between the player virtual object and the AI virtual object, a virtual object type of the AI virtual object, a body size of the AI virtual object, a current position of the AI virtual object, whether the player virtual object is currently in an active state, whether the player virtual object moves in a virtual scenario, and whether the player virtual object is in a special state.

In conclusion, in embodiments of this application, in a case of an AI virtual object located within an observation range of a player virtual object, a current LOD of the AI virtual object is determined based on at least two levels of LOD determining strategies corresponding to the AI virtual object such that the AI virtual object can be controlled according to a control strategy corresponding to the current LOD. Thus, determining standards for determining the LOD of the AI virtual object are enriched, and diversity of strategies for controlling the AI virtual object is increased. Moreover, in embodiments of this application, different LOD determining strategies each include at least two determining sub-strategies. Different determining sub-strategies correspond to determining bases in different dimensions. Relatively rich dimensions are considered in a process of determining an LOD such that reliability of determining an LOD can be improved. Thus, reliability of a control strategy corresponding to an AI virtual object can be improved, unnecessary power consumption can be reduced, and a display effect of the AI virtual object in a virtual scenario can be optimized. Further, visual experience of a player can be improved, and a human-computer interaction rate can be improved.

The apparatus provided in the above embodiments is illustrated only with an example of division of the above function modules. During practical application, the above functions may be allocated to be completed by different function modules according to requirements. That is, the internal structure of the apparatus is divided into different function modules to complete all or some of the functions described above. In addition, the apparatus and method embodiments provided in the above embodiments belong to the same conception. Reference can be made to the method embodiments for an implementation process, which will not be repeated herein.

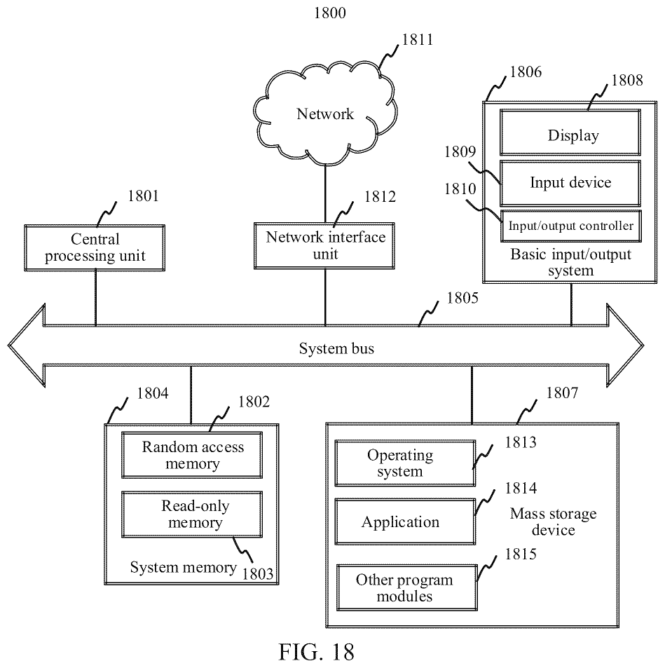

With reference to FIG. 18, a schematic structural diagram of a computer device according to an exemplary embodiment of this application is shown. Specifically, the computer device 1800 includes a central processing unit (CPU) 1801, a system memory 1804 including a random access memory 1802 and a read-only memory 1803, and a system bus 1805 connecting the system memory 1804 and the central processing unit 1801. The computer device 1800 further includes a basic input/output (I/O) system 1806 assisting in information transmission between devices in the computer, and a mass storage device 1807 configured to store an operating system 1813, an application 1814, and other program modules 1815.

The basic input/output system 1806 includes a display 1808 configured to display information and an input device 1809 such as a mouse or a keyboard that is used for inputting information by a user. The display 1808 and the input device 1809 are both connected to the central processing unit 1801 by using an input/output controller 1810 connected to the system bus 1805. The basic input/output system 1806 may further include the input/output controller 1810 to be configured to receive and process inputs from a plurality of other devices such as a keyboard, a mouse, and an electronic stylus. Similarly, the input/output controller 1810 further provides an output to a display screen, a printer, or another type of output device.

The mass storage device 1807 is connected to the central processing unit 1801 by using a mass storage controller (not shown) connected to the system bus 1805. The mass storage device 1807 and a computer-readable medium associated with the mass storage device provide non-transitory computer-readable storage for the computer device 1800. In other words, the mass storage device 1807 may include a computer-readable medium (not shown) such as a hard disk or a drive.

Without loss of generality, the computer-readable medium may include a computer storage medium and a communication medium. The computer storage medium includes volatile and non-volatile media, and removable and non-removable media implemented by using any method or technology used for storing information such as computer-readable instructions, data structures, program modules, or other data. The computer storage medium includes a random access memory (RAM), a read only memory (ROM), a flash memory or another solid-state storage technology, a compact disc read-only memory (CD-ROM), a digital versatile disc (DVD) or another optical memory, a magnetic cassette, a magnetic tape, a magnetic disk memory, or another magnetic storage device. Certainly, a person skilled in the art may know that the computer storage medium is not limited to the above several types. The system memory 1804 and the mass storage device 1807 mentioned above may be collectively referred to as a memory.

The memory stores one or more programs. The one or more programs are configured to be executed by one or more central processing units 1801. The one or more programs include instructions for implementing the above methods. The central processing unit 1801 executes the one or more programs to implement the methods provided in the above method embodiments.

According to embodiments of this application, the computer device 1800 may further be connected, through a network such as the Internet, to a remote computer on the network to run. That is, the computer device 1800 may be connected to a network 1811 by using a network interface unit 1812 connected to the system bus 1805, or may be connected to another type of network or a remote computer system (not shown) by using a network interface unit 1812.

An embodiment of this application further provides a non-transitory computer-readable storage medium. At least one instruction is stored in the non-transitory computer-readable storage medium. The at least one instruction is loaded and executed by a processor, to cause a computer to implement the method for controlling an AI virtual object mentioned in the above embodiment.

In some embodiments, the non-transitory computer-readable storage medium may include: an ROM, an RAM, a solid state drive (SSD), an optical disc, etc. The RAM may include a resistance random access memory (ReRAM) and a dynamic random access memory (DRAM).

An embodiment of this application provides a computer program product or a computer program. The computer program product or the computer program includes a computer instruction. The computer instruction is stored in a non-transitory computer-readable storage medium. A processor of a computer device reads the computer instruction from the non-transitory computer-readable storage medium. The processor executes the computer instruction, to cause the computer device to execute the method for controlling an AI virtual object mentioned in the above embodiments.

A person of ordinary skill in the art may understand that all or some of the operations for implementing the above embodiments may be implemented by hardware, or may be implemented by a program instructing relevant hardware. The program may be stored in a non-transitory computer-readable storage medium. The storage medium mentioned above may be a read-only memory, a magnetic disk, an optical disc, etc.

In this application, the term “module” or “unit” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module or unit can be implemented using one or more processors (or processors and memory). Likewise, a processor (or processors and memory) can be used to implement one or more modules or units. Moreover, each module or unit can be part of an overall module or unit that includes the functionalities of the module or unit. The above descriptions are merely embodiments of this application, and not used to limit this application. Any modifications, equivalent substitutions, improvements, etc. made within the principle of this application should all fall within the scope of protection of this application.

What is claimed is:

1. A method for controlling an artificial intelligence (AI) virtual object in a virtual environment performed by a computer device and the method comprising:
determining an AI virtual object located within an observation range of a player virtual object;
determining a current level of details (LOD) of the AI virtual object based on at least two levels of LOD determining strategies corresponding to the AI virtual object, wherein the current LOD is an LOD corresponding to a target LOD determining strategy which the AI virtual object satisfies; and
controlling, based on a control strategy corresponding to the current LOD, the AI virtual object to carry out an activity in the virtual environment.

2. The method according to claim 1, wherein the determining a current LOD of the AI virtual object based on at least two levels of LOD determining strategies corresponding to the AI virtual object comprises:
acquiring an i^{th}-level LOD determining strategy corresponding to the AI virtual object, i being an integer; and
determining, when a strategy determining result of the i^{th}-level LOD determining strategy represents that the AI virtual object satisfies the i^{th}-level LOD determining strategy, an LOD corresponding to the i^{th}-level LOD determining strategy as the current LOD.

3. The method according to claim 2, further comprising:
acquiring, when the strategy determining result of the i^{th}-level LOD determining strategy represents that the AI virtual object does not satisfy the i^{th}-level LOD determining strategy, an (i+1)^{th}-level LOD determining strategy corresponding to the AI virtual object.

4. The method according to claim 3, wherein the LOD corresponding to the i^{th}-level LOD determining strategy is higher than an LOD corresponding to the (i+1)^{th}-level LOD determining strategy.

5. The method according to claim 2, wherein after the acquiring an i^{th}-level LOD determining strategy corresponding to the AI virtual object, the method comprises:
determining, when the i^{th}-level LOD determining strategy is related to the AI virtual object, the strategy determining result of the i^{th}-level LOD determining strategy based on an AI object parameter of the AI virtual object;
determining, when the i^{th}-level LOD determining strategy is related to the player virtual object, the strategy determining result of the i^{th}-level LOD determining strategy based on a player object parameter of the player virtual object; or
determining, when the i^{th}-level LOD determining strategy is related to the player virtual object and the AI virtual object, the strategy determining result of the i^{th}-level LOD determining strategy based on a player object parameter of the player virtual object and an AI object parameter of the AI virtual object.

6. The method according to claim 2, wherein after the acquiring an i^{th}-level LOD determining strategy corresponding to the AI virtual object, the method comprises:
determining a sub-strategy determining result of each determining sub-strategy of the i^{th}-level LOD determining strategy; and
carrying out a logical operation on each sub-strategy determining result, and obtaining the strategy determining result of the i^{th}-level LOD determining strategy.

7. The method according to claim 1, wherein a plurality of AI virtual objects are provided, before the determining a current LOD of the AI virtual object based on at least two levels of LOD determining strategies corresponding to the AI virtual object, the method further comprises:
clustering the AI virtual objects based on the AI object parameter of the AI virtual object, and obtaining an AI virtual object cluster, the AI object parameter comprising at least one type of an AI object type, AI object coordinates, and an AI object state;
determining, in a case of a target AI virtual object cluster of the AI virtual object cluster, a current LOD of the target AI virtual object cluster based on at least two levels of LOD determining strategies corresponding to a target AI virtual object in the target AI virtual object cluster; and
controlling, based on the control strategy corresponding to the current LOD, each AI virtual object in the target AI virtual object cluster to carry out an activity in the virtual environment.

8. The method according to claim 1, wherein the LOD determining strategy is related to at least the player virtual object, and at least two player virtual objects exist in the virtual environment; and
the determining a current LOD of the AI virtual object based on at least two levels of LOD determining strategies corresponding to the AI virtual object comprises:
determining, in a case of each of the at least two player virtual objects, a candidate LOD of the AI virtual object under an impact of the player virtual object based on the at least two levels of LOD determining strategy corresponding to the AI virtual object; and
determining a highest LOD of candidate LODs as the current LOD of the AI virtual object.

9. The method according to claim 1, wherein the control strategy corresponding to the current LOD comprises at least one of target AI control logic and a target logic running frequency, complexity of the AI control logic is positively correlated with an LOD, and the logic running frequency is positively correlated with an LOD.

10. A computer device, comprising a processor and a memory, the memory having at least one instruction stored therein, and the at least one instruction, when executed by the processor, causing the computer device to implement a method for controlling an AI virtual object in a virtual environment including:
determining an AI virtual object located within an observation range of a player virtual object;
determining a current level of details (LOD) of the AI virtual object based on at least two levels of LOD determining strategies corresponding to the AI virtual object, wherein the current LOD is an LOD corresponding to a target LOD determining strategy which the AI virtual object satisfies; and
controlling, based on a control strategy corresponding to the current LOD, the AI virtual object to carry out an activity in the virtual environment.

11. The computer device according to claim 10, wherein the determining a current LOD of the AI virtual object based on at least two levels of LOD determining strategies corresponding to the AI virtual object comprises:
acquiring an i^{th}-level LOD determining strategy corresponding to the AI virtual object, i being an integer; and
determining, when a strategy determining result of the i^{th}-level LOD determining strategy represents that the AI virtual object satisfies the i^{th}-level LOD determining strategy, an LOD corresponding to the i^{th}-level LOD determining strategy as the current LOD.

12. The computer device according to claim 11, wherein the method further comprises:
acquiring, when the strategy determining result of the i^{th}-level LOD determining strategy represents that the AI virtual object does not satisfy the i^{th}-level LOD determining strategy, an (i+1)^{th}-level LOD determining strategy corresponding to the AI virtual object.

13. The computer device according to claim 12, wherein the LOD corresponding to the i^{th}-level LOD determining strategy is higher than an LOD corresponding to the (i+1)^{th}-level LOD determining strategy.

14. The computer device according to claim 11, wherein after the acquiring an i^{th}-level LOD determining strategy corresponding to the AI virtual object, the method comprises:
determining, when the i^{th}-level LOD determining strategy is related to the AI virtual object, the strategy determining result of the i^{th}-level LOD determining strategy based on an AI object parameter of the AI virtual object;
determining, when the i^{th}-level LOD determining strategy is related to the player virtual object, the strategy determining result of the i^{th}-level LOD determining strategy based on a player object parameter of the player virtual object; or
determining, when the i^{th}-level LOD determining strategy is related to the player virtual object and the AI virtual object, the strategy determining result of the i^{th}-level LOD determining strategy based on a player object parameter of the player virtual object and an AI object parameter of the AI virtual object.

15. The computer device according to claim 11, wherein after the acquiring an i^{th}-level LOD determining strategy corresponding to the AI virtual object, the method comprises:
determining a sub-strategy determining result of each determining sub-strategy of the i^{th}-level LOD determining strategy; and
carrying out a logical operation on each sub-strategy determining result, and obtaining the strategy determining result of the i^{th}-level LOD determining strategy.

16. The computer device according to claim 10, wherein a plurality of AI virtual objects are provided, before the determining a current LOD of the AI virtual object based on at least two levels of LOD determining strategies corresponding to the AI virtual object, the method further comprises:
clustering the AI virtual objects based on the AI object parameter of the AI virtual object, and obtaining an AI virtual object cluster, the AI object parameter comprising at least one type of an AI object type, AI object coordinates, and an AI object state;
determining, in a case of a target AI virtual object cluster of the AI virtual object cluster, a current LOD of the target AI virtual object cluster based on at least two levels of LOD determining strategies corresponding to a target AI virtual object in the target AI virtual object cluster; and
controlling, based on the control strategy corresponding to the current LOD, each AI virtual object in the target AI virtual object cluster to carry out an activity in the virtual environment.

17. The computer device according to claim 10, wherein the LOD determining strategy is related to at least the player virtual object, and at least two player virtual objects exist in the virtual environment; and
the determining a current LOD of the AI virtual object based on at least two levels of LOD determining strategies corresponding to the AI virtual object comprises:
determining, in a case of each of the at least two player virtual objects, a candidate LOD of the AI virtual object under an impact of the player virtual object based on the at least two levels of LOD determining strategy corresponding to the AI virtual object; and
determining a highest LOD of candidate LODs as the current LOD of the AI virtual object.

18. The computer device according to claim 10, wherein the control strategy corresponding to the current LOD comprises at least one of target AI control logic and a target logic running frequency, complexity of the AI control logic is positively correlated with an LOD, and the logic running frequency is positively correlated with an LOD.

19. A non-transitory computer-readable storage medium, having at least one instruction stored therein, and the at least one instruction, when executed by a processor of a computer device, causing the computer device to implement a method for controlling an AI virtual object in a virtual environment including:
determining an AI virtual object located within an observation range of a player virtual object;
determining a current level of details (LOD) of the AI virtual object based on at least two levels of LOD determining strategies corresponding to the AI virtual object, wherein the current LOD is an LOD corresponding to a target LOD determining strategy which the AI virtual object satisfies; and
controlling, based on a control strategy corresponding to the current LOD, the AI virtual object to carry out an activity in the virtual environment.

20. The non-transitory computer-readable storage medium according to claim 19, wherein the method further comprises:
acquiring, when the strategy determining result of the i^{th}-level LOD determining strategy represents that the AI virtual object does not satisfy the i^{th}-level LOD determining strategy, an (i+1)^{th}-level LOD determining strategy corresponding to the AI virtual object.
